(19) United States
(12) Patent Application Publication
(10) Pub. No.: US 2025/0348153 A1
(43) Pub. Date: Nov. 13, 2025

(54) COMPUTING DEVICE WITH IMPROVED USER INTERFACE FOR ENTERING SPECIAL CHARACTERS

(71) Applicant: Keith Ng, Singapore (SG)

(72) Inventor: Keith Ng, Singapore (SG)

(21) Appl. No.: 19/009,433

(22) Filed: Jan. 3, 2025

Related U.S. Application Data
(60) Provisional application No. 63/644,721, filed on May 9, 2024.

(51) Int. Cl. G06F 3/023

(52) U.S. Cl. CPC G06F 3/0233

(57) ABSTRACT

The present disclosure offers an improved user interface for selecting and entering special characters in digital text, among other capabilities. When a character key is press and held, a related special character is displayed at a text cursor or input insertion point, replacing the previously displayed keyboard character. When the key remains held down, other related special characters are automatically cycled in a continuous loop until the key is released. Display of special characters are prioritized based on various criteria, including usage history and contextual factors. This enhances typing efficiency by reducing the number of keystrokes and/or mouse movements conventionally required, thus simplifying the input of special characters. It is particularly useful for multilingual users and those requiring access to special characters. The system is adaptive, learning from user behavior to improve accuracy and relevance over time.

### RELATED APPLICATION(S)

This application claims the benefit of U.S. Provisional Application No. 63/644,721, filed on May 9, 2024. The entire teachings of the above application(s) are incorporated herein by reference.

### TECHNICAL FIELD

The present disclosure relates to a computing device with an improved user interface for selecting and entering special characters. The term “computing device” refers to any kind of device that can process and display information.

### BACKGROUND

In the last two decades, advancements in technology and the broad adoption of Unicode—a character encoding standard that supports a vast array of characters and symbols—have enabled consistent representation of special characters across various platforms and devices, greatly enriching digital communication. However, entering characters and symbols that are not readily available on standard keyboards can often be time-consuming, complex, and difficult to learn, particularly to novice users. As such, it is of interest to provide an improved solution which addresses this problem.

### BRIEF DESCRIPTION OF THE DRAWINGS

The accompanying drawings illustrate various embodiments and implementations, and are provided for illustrative purposes only. Drawings, including representations of components and processes, are simplified, omitting certain details to avoid obscuring the inventive concept. These drawings do not exhaustively represent all configurations, and the relationships between components are schematic. Modifications and variations may be made without departing from the overall inventive concept, in which:

FIGS. 1A-1N illustrate exemplary user interface interactions between user inputs and display outputs, organized in a flow sequence to facilitate clarity and comprehension.

FIGS. 2A-2P illustrate additional exemplary user interface interactions between user inputs and display outputs, organized in a new flow sequence to facilitate clarity and comprehension.

FIGS. 3A-3E are schematic block diagrams illustrating various embodiments of a computing device.

FIG. 4 is a schematic block diagram illustrating one embodiment of a memory device included in the computing devices of FIGS. 3A-3E.

FIGS. 5A-5X is an example schematic representation of data stored in a repository, highlighting the organization and associations between various keyboard characters and special characters, according to one implementation an embodiment. FIG. 5A shows an initial portion.

FIGS. 5B-5X continue with additional entries.

FIG. 6 is a schematic flow chart diagram illustrating one implementation of a method for monitoring, intercepting, processing, and responding to keystrokes in accordance with the invention.

FIG. 7 is a schematic flow chart diagram illustrating one implementation of a method for character cycling in accordance with the invention.

FIGS. 8A-8G is an example pseudocode listing for one implementation of a special characters repository, key receiver and interceptor module, and character cycling module.

FIG. 9 is a schematic block diagram illustrating another embodiment of a memory device included in the computing devices of FIGS. 3A-3E.

FIG. 10 is a conceptual overview of one implementation of a character ranking module that assigns values or importance to different characters based on certain criteria.

FIGS. 11-13 are schematic block diagrams illustrating various embodiments of a Computer Program Product.

FIGS. 14-15 are schematic block diagrams illustrating various implementations of components of a Computer Program Product.

### DETAILED DESCRIPTION

Despite the widespread adoption of Unicode that has enabled consistent representation of characters across various platforms, devices, and applications, the process of entering characters that are not readily available on a keyboard presents challenges for users.

Some prior art methods for inserting special characters require users to memorize and enter complex key sequences or arbitrary character code combinations. These keyboard shortcuts, while intended to streamline the process, are often cognitively taxing, demanding considerable effort and practice to master. Furthermore, such shortcuts are often platform-dependent, varying between operating systems, and can even differ among applications, adding another layer of complexity for users. Additionally, pressing multiple keys simultaneously or in a constrained order can feel awkward and raise ergonomic concerns. For users with manual dexterity challenges or visual impairments, locating and activating these keys can be a daunting task.

Other prior art approaches allow users to visually select characters from a row or grid of options, such as character palettes or pop-up selectors. However, these methods generally require users to shift their visual attention between the text cursor and the selection interface, disrupting the natural flow of the typing process. This shifting of visual focus often derails the user's train of thought, requiring them to visually reorient themselves to resume typing after selecting a character. Additionally, character palettes or pop-up selectors may obscure existing text, further hindering the user's flow. While such prior art screen-selection entry approaches provide some accessibility, they often result in a cluttered, chaotic interface that can overwhelm users. Indeed, navigating through tabs and menus to find a desired special character can feel like searching for a needle in a haystack, further consuming time and focus.

As a result, many users perceive the act of entering special characters as complex, time-consuming, or even frustrating. This struggle may lead them to avoid using typographical symbols altogether. For instance, users might opt to write “67 degF” instead of the more precise “67° F.”, or they may resort to typing multiple hyphens (e.g., “--” or “---”) as substitutes for en (“-”) and em (“—”) dashes. Additionally, common alphabetic approximations, such as “(TM)” or “(c)”, are used in place of the trademark symbol “™” or copyright symbol “©”, further illustrating the challenge.

Thus, there exists a compelling need for an improved solution that facilitate the easy, efficient, and natural entry of special characters.

Aspects of this disclosure address challenges associated with entering special characters, reducing user cognitive load and enhancing typing efficiency and productivity. The features of this disclosure provide a synergistic benefit that optimizes special character selection and entry while also offering broader applicability beyond this specific context. As will be recognized by those skilled in the art, various aspects of the disclosure may be embodied in a computing device, apparatus, computer program, or computer program component, and may be implemented in or realized as part of a user interface feature, or practiced as a method, including any contemplated variations, combinations, or modifications thereof.

For the purposes of this specification, a “key input interface” refers to any device, component, hardware, software, mechanism, or combination thereof—whether known or developed in the future—that translates user input through the use of keys, key-like elements, or key-like gestures into corresponding commands or data for processing by a computing device. A key input interface may exist as an external peripheral, an integrated component within a computing device, a visual element presented on or projected from a display, or a combination thereof. Examples of key input interfaces include, but are not limited to: physical keyboards, virtual keyboards, keypads, macropads, onscreen keyboards, touchscreen-based virtual keyboards, optical virtual keyboards, augmented reality keyboards, virtual reality keyboards, gesture-based input systems, motion-tracking interfaces, eye-tracking systems, brain-machine interfaces, and hybrid systems that combine both physical and virtual keys, as well as other input devices that employ any or a combination of keys, key-like elements, key-like gestures, key-like motion, or other mechanisms for data entry.

For the purposes of this specification, the term “keyboard” is used to refer to any “key input interface” as defined herein.

For the purposes of this specification, the term “character” refers to any symbol, sign, glyph, notation, or graphical representation used in written language or data processing. This includes, but is not limited to, letters, numbers, whitespace elements, punctuation marks, diacritical marks, typographic marks, special symbols, mathematical, scientific, financial, technical, or other orthographic symbols, signs, glyphs, notations, as well as emojis, which together form the basis of textual representation as may be used in various fields and languages. A “character” is not confined to a specific visual representation; for example, the “character” “A” signifies the letter “A” regardless of how it looks or is rendered in different fonts or styles. Furthermore, “character” can also refer to multiple units of “characters”; for example, “° C.” while consisting of two distinct characters (° and C), can be considered as a single “character” in this specification. Similarly, an ellipsis represented by three spaced periods “ . . . ”, while consisting of five characters, can also be considered as a single “character.” Additionally, a “character” may be composed of one or more basic units of encoding; for example, the x bar (x̅) symbol, while rendered on a display as a single character, consists of two Unicode code points: U+0078 and U+0304, where U+0304 is a combining diacritical mark.

For the purposes of this specification, a “special character” refers to any one or more characters or symbols that are not an “alphanumeric character.” An “alphanumeric character” refers to any character selected from the group consisting of a-z, A-Z, and 0-9.

For the purposes of this specification, a “keyboard character” or “key character” refers to any one or more characters and/or symbols that can be ordinarily generated through a given key input interface, including any applied keyboard layout. This includes characters produced with modifier key(s), such as pressing Shift+A to produce keyboard character “A” (while pressing A alone produces keyboard character “a”), and characters like “4” and “$” that share a key on a US keyboard layout, where pressing the key alone generates keyboard character “4” and pressing Shift+4 generates keyboard character “$”. It also encompasses instances where toggle key(s) like Caps Lock are activated; for example, if Caps Lock is on and the A key is pressed, the keyboard character is “A”. Additionally, a keyboard character may also be a special character, such as the special characters “²” and “³”, which are readily available on a German keyboard layout.

For the purposes of this specification, a “character key” is defined as a key on a key input interface (such as a physical or virtual keyboard) that, when actuated, generates or is capable of generating a specific character or whitespace output. This includes alphanumeric keys, punctuation keys, and the space bar. A character key may also be used in conjunction with a modifier key. For example, when the 4/$ key is pressed simultaneously with a modifier key, such as Shift, the $ symbol is conventionally produced. In this case, either “4/$” or “$” may be referred to as the “character key.”

For the purposes of this specification, the term “text cursor” refers to any visual indicator that shows the current position for input or editing within a digital interface, such as a blinking line or block. A “text cursor” may also refer to an invisible or non-visual indicator where the input insertion point is implied through the sequential nature of input, as seen in devices such as handheld calculators. Therefore, the terms “text cursor” and “input insertion point” may be used interchangeably throughout this specification, whether or not a specific visual indicator is present.

In general, in one aspect, the present invention provides methods, apparatus, and computer program products implementing techniques that offer an improved approach to human-computer interaction for selecting and entering special characters. The term “Computer Program Product,” as used herein, refers to software or instructions stored on a non-transitory computer-readable medium that, when executed by a computing device or apparatus, perform the operations described herein. The Computer Program Product may be implemented at various levels, including as part of an operating system, middleware, or an application. In some embodiments, the Computer Program Product may be implemented in firmware or hardware as part of an apparatus, such as a smart keyboard, which refers to a keyboard apparatus equipped with embedded firmware or hardware features that enable enhanced functionality. Such implementations enable the described functionality directly within the apparatus. When a character key on a key input interface is pressed and held for at least a predetermined threshold duration, the computing device initiates automatic cycling through a set of special characters. This threshold duration ensures that the sequence is not triggered by accidental or brief key presses; the key must be held down deliberately for the sequence to start. Each special character from a set of characters associated with the pressed key, including the original key character, is displayed sequentially. Importantly, each special character appears directly at the text cursor position, exactly where the user is typing, without any overlay or separate graphical layer. For example, if the user is typing “San Jos” in a document and presses and holds the E key, the special character é appears directly at the text cursor within the document, in line with the surrounding text (resulting in “San José”). As the user continues to hold the key, other special characters related to the E key may cycle in that same spot, sequentially replacing é at the cursor position. When the user releases the key, the currently displayed character is entered at the text cursor position, just like any standard typed character. This inline cycling continues uninterrupted until the character key is released, at which point the selected character is committed to the text. To facilitate seamless browsing, the sequence wraps around to the first special character in the set after the last character has been displayed. This configuration enhances user interaction by providing an efficient and intuitive way to select and enter special characters exactly where the user is typing, without requiring repetitive key presses or complex menu navigation.

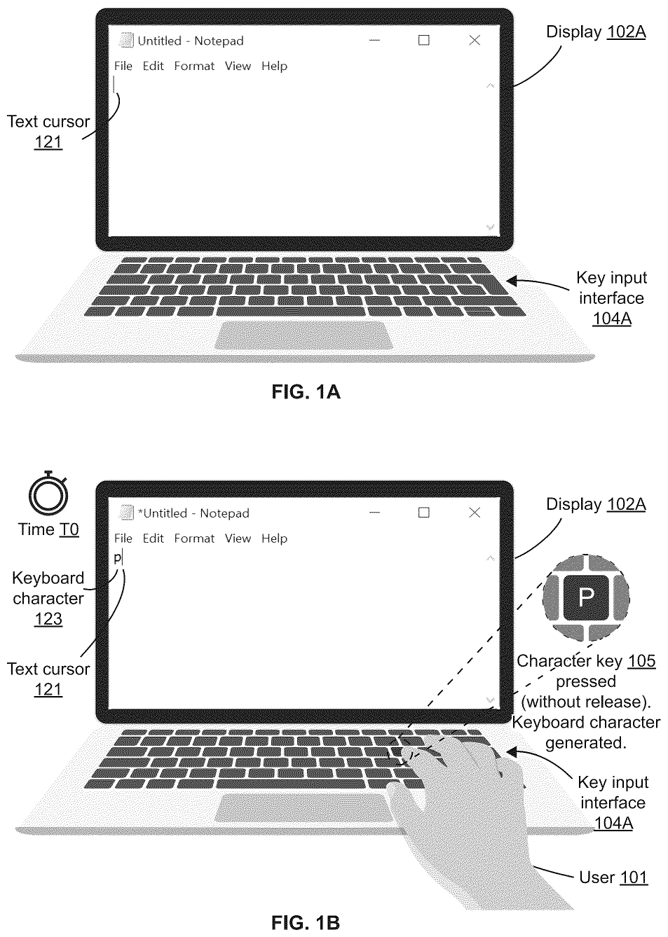

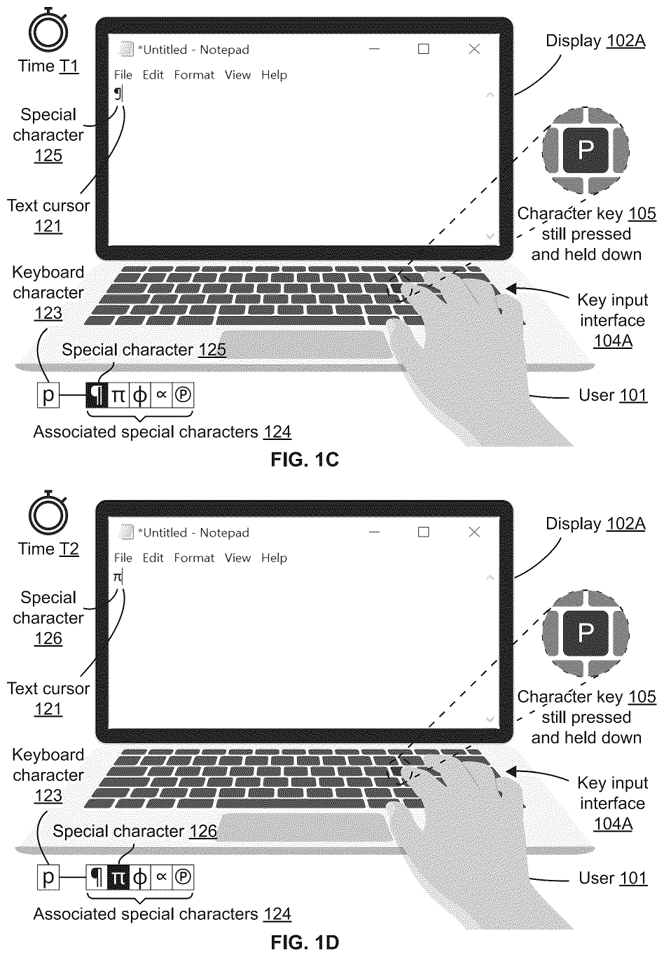

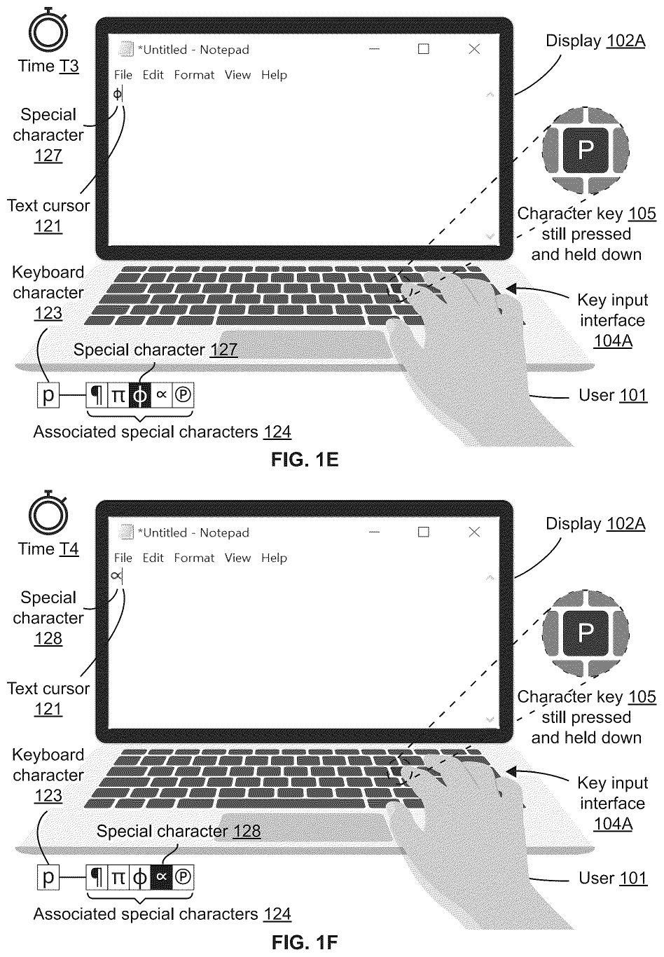

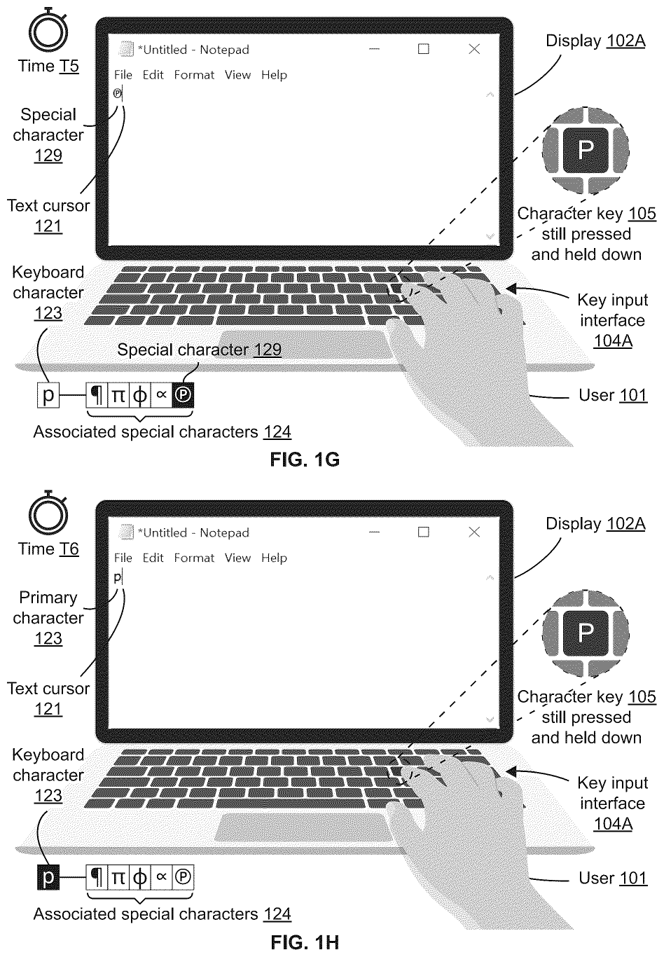

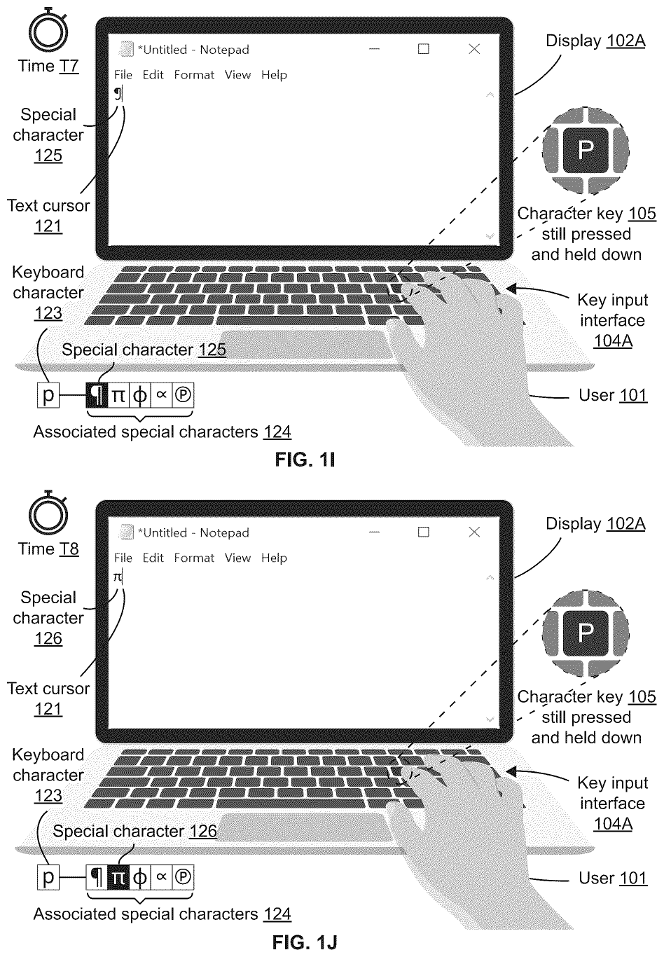

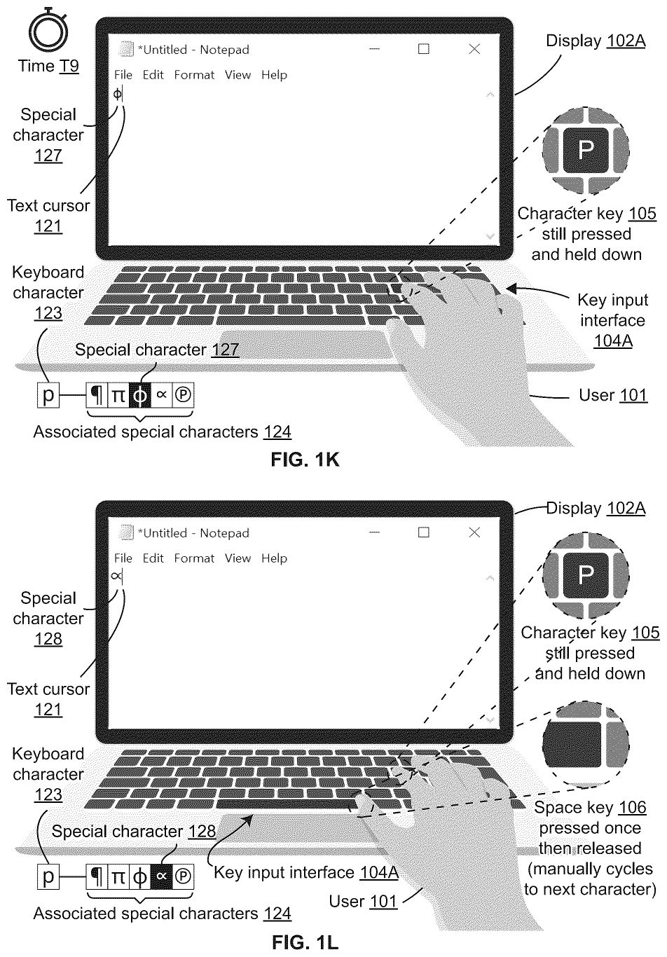

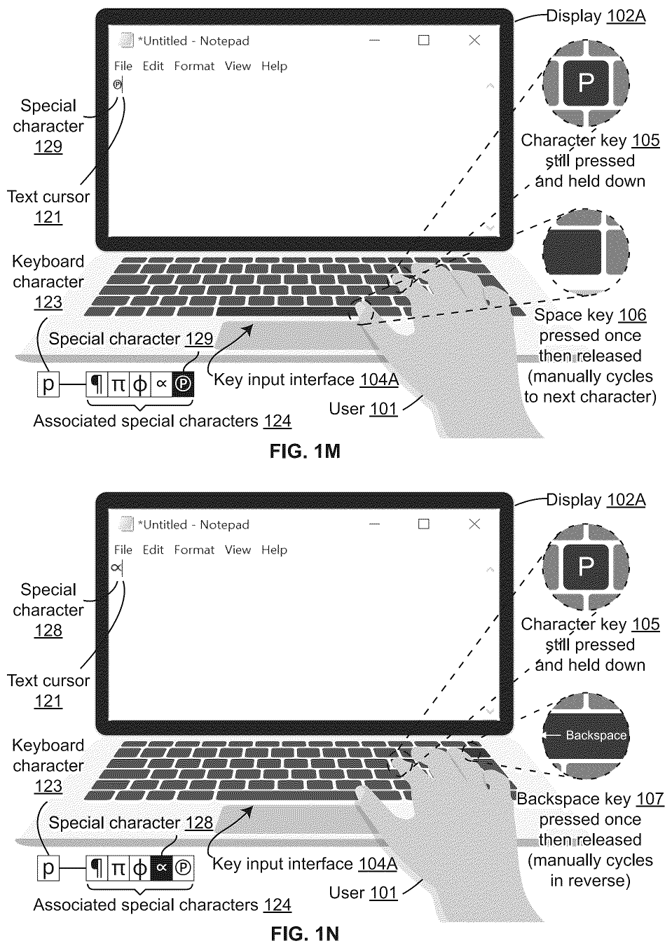

In one specific implementation, a paragraph mark (¶) can be produced by holding down the P key, which initially—following conventional behavior—causes a “p” character to be inserted at the text cursor position in an active text field. After approximately one second, the “p” character at the cursor begins to automatically cycle through a set of characters associated with the P key, including both the standard character and related special characters, at approximately one-second intervals. The automatic cycling continues until the P key is released. For example, if the P key is associated with the characters “¶”, “π”, “Φ”, “∝”, and “ [symbol] ” in that order, the cycling sequence transitions as follows: “¶”→“π”→“Φ”→“∝”→“ [symbol] ”→“p”, looping continuously while the P key remains held. This automatic cycling behavior is illustrated in FIGS. 1A through 1K for ease of understanding.

One key advantage of this user interface over prior-art elements like pop-up windows or graphical overlays is its ability to minimize eye movement during interaction, which enhances user efficiency and comfort. By keeping the cycling characters consistently positioned at the text cursor, the need for users to shift their gaze is reduced or eliminated. This minimizes cognitive load, allowing for faster character selection and an overall improvement in typing efficiency. Additionally, this ergonomic design keeps the user's visual focus near the cursor, preventing distractions and further streamlining the selection process. As a result, users can select special characters more quickly and effortlessly, leading to increased productivity and an enhanced typing experience.

Another key advantage is that only a limited set of special character options associated with a pressed key is displayed, reducing potential distractions.

Advantageous implementations may include dynamic character ordering to maximize the findability of special characters by prioritizing them based on the context of the user's input, such as by using a dictionary repository or language database to infer the active language, with further techniques discussed in the following pages. For example, if a user types “fronti” and triggers special characters for “e” by pressing and holding down the E key, the system might prioritize “è” to match the French word “frontière.” If the user then completes the word as “frontière,” the system can infer that French is the active language. Later, if the user types “ma” and triggers special characters for “i” by pressing and holding down the I key, the system may prioritize “î” and “ï” (as in the French words “maître” and “maïs”) over special i characters from other languages, such as í or ì. This prioritization occurs because the system detects French as the active language, adapting character suggestions accordingly based on the dictionary repository. With a single keyboard layout, this technology can accommodate users proficient in multiple Latin-based languages—such as English, Spanish, French, Italian, Portuguese, German, Dutch, Swedish, Norwegian, and Danish—enabling access to necessary characters without requiring a switch between keyboard layouts, as is traditionally necessary. This context-aware approach simplifies the typing process by reducing the need for frequent layout changes, facilitating more fluid input across languages. As a result, users may experience enhanced typing efficiency and a more intuitive, seamless special character entry. Additionally, this approach may reduce the need for supplementary input devices or specialized keycaps that some users purchase to access specific characters. By potentially minimizing the need for extra hardware, this solution may also contribute to reduced electronic waste, making it a more environmentally friendly option.

Another aspect of this disclosure associates special characters with one or more keys through simple, easy-to-remember relationships, such as spelling, shape, or meaning. For example, pressing and holding the B key may invoke the special character: (meaning “because”), and pressing and holding the T key may invoke θ (theta), both based on the first letter of the character's name. Another example involves the * key, which may invoke [symbol] due to visual similarity. Similarly, pressing and holding the + key may invoke symbols such as ±, ∓, and ⊕, while the/key may invoke: due to their shared meaning of division in mathematical contexts. This approach enhances user learnability, making the system intuitive and efficient to use.

Moreover, this disclosure may promote standardization in character input across different platforms and applications by enabling implementation at a low level within an operating system. This approach allows the solution to function consistently across all applications without requiring modifications to those applications, fostering a consistent and cohesive user experience.

Furthermore, the disclosure may additionally or alternatively provide other suitable benefits.

For the purposes of this specification, a computer program refers to any set of instructions executable by a computing device to perform a specific task or set of tasks. A computer program may be written in any programming language(s) and executed directly by a processor or indirectly via an interpreter or virtual machine. A computer program includes, but is not limited to, user applications, utility programs, web applications, system software, and other software. Additionally, a computer program encompasses operating system programs, which are specialized software or sets of software components that are part of, or operate within, the operating system (OS) of a computing device. These operating system programs may include system services, kernel modules, device drivers, background processes, and other system-level software.

The disclosure may be embodied as a computer program implemented, for example, as a background service, kernel module, or a low-level input processing program within the operating system. This program intercepts and responds to keyboard events (key presses and releases) before they are processed by other applications. As a result, the feature operates systemwide, across all applications, without requiring modifications to those applications. This ensures that the feature is available in the user's preferred applications, without the need for additional configuration or setup.

For the purposes of this specification, a computer program component refers to any software module, feature, or subsystem that is part of a larger computer program. A computer program component performs a specific task, provides a particular functionality, or contributes to the overall operation of the computer program. It may be modular and independently deployable, or it may operate as part of a larger software system, without necessarily being a standalone program. For example, a computer program component may be a specific feature within a word processing application, a module of a web application, or a subsystem within a larger software system.

As used herein, a “content element” refers to any displayable item, including but not limited to character(s), text string(s), image(s), icon(s), graphical symbol(s), any other form of visual representation, or any combination thereof. A content element that comprises one or more characters may be displayed in any font, style, or size, or without any specific visual styling.

Accordingly, embodiments may manifest as an entirely hardware implementation, an entirely software implementation (including firmware, resident software, micro-code, etc.), or a combination of both hardware and software, which may collectively be referred to herein as a “circuit,” “module,” or “system.” Moreover, embodiments may exist as a program product stored on one or more computer-readable storage devices containing machine-readable code, computer-readable code, and/or program code, collectively referred to as “code.” These storage devices may be tangible, non-transitory, and/or non-transmission mediums. These storage devices do not represent signals, but may utilize signals solely for the purpose of accessing the code.

Many of the functional units described in this specification are referred to as “modules” to emphasize their implementation independence. For example, a module may be realized as a hardware circuit that comprises custom VLSI circuits, gate arrays, off-the-shelf semiconductors (such as logic chips, transistors, or other discrete components), or combinations thereof. Additionally, a module may be implemented using programmable hardware devices, such as field-programmable gate arrays (FPGAs), programmable array logic (PALs), programmable logic devices (PLDs), or similar technologies.

Modules may also be implemented in code and/or software for execution by various types of processors. An identified module of code may, for example, comprise one or more physical or logical blocks of executable code, which can be organized as an object, procedure, or function. The executables of an identified module do not need to be physically grouped together; rather, they may be stored in different locations, but when logically combined, they function as a cohesive module to fulfill its intended purpose.

Indeed, a module of code may comprise a single instruction or many instructions, and it may even be distributed across several different code segments, within different programs, and across multiple memory devices. Similarly, operational data may be identified and illustrated herein within modules and can be embodied in any suitable form and organized within any appropriate type of data structure. The operational data may be collected as a single data set or distributed across various locations, including different computer-readable storage devices. Where a module or portions thereof are implemented in software, the software module or portions thereof are stored on one or more computer-readable storage devices.

Any combination of one or more computer-readable media may be utilized. The computer-readable media may comprise a computer-readable storage medium. The computer-readable storage medium may consist of a storage device that stores the code. The storage device may be, for example, but not limited to, an electronic, magnetic, optical, electromagnetic, infrared, holographic, micromechanical, or semiconductor system, apparatus, or device, or any suitable combination thereof.

For the purposes of this specification, the terms “key press” and “key release” are also referred to as “key down” and “key up,” respectively. “Key press” refers to the act of pressing down a key on a key input interface, such as a keyboard or keypad, and “key release” refers to the action of releasing a key on the same interface. For clarity, the term “key press,” or similar grammatical variations such as “press a key,” alone may not imply that the key is immediately released; that is, a “key press” could involve pressing and holding the key down. Additionally, the terms “key activation” and “hit a key,” or grammatical variants such as “activate a key,” may refer to the act of pressing down a key and/or the combined action of pressing down and releasing the key. The term “keystroke” refers to any interaction with a key on a key input interface, which includes both the pressing down (key down) and releasing (key up) of the key.

Turning now to the drawings, FIG. 1A illustrates key user interface elements of one embodiment, comprising an example display 102A, an example key input interface 104A, and an example text cursor 121. These elements work in conjunction to facilitate user input and interaction.

FIG. 1B (at time T0), flowing from FIG. 1A, illustrates an example display output when a user (such as user 101 in this example) presses down a character key (such as a character key 105 [P key] in this example) on the key input interface 104A. A keyboard character (such as keyboard character 123 “p” in this example) is displayed, and the text cursor 121 advances one character position from FIG. 1A to its new location in this figure, demonstrating prior-art behavior.

FIG. 1C (at time T1), following FIG. 1B, illustrates an example display output occurring approximately one second after FIG. 1B (Time T0). During this time, the user 101 continues to hold down the character key (such as the character key 105), prompting the removal of the previously displayed keyboard character (“p” in FIG. 1B) and the display of a first special character (such as special character 125, “¶”) from a set of special characters associated with the keyboard character (such as associated special characters 124).

The interval between T1 and T0, or the delay time, represents the key down (press-and-hold) duration necessary to initiate “character cycling,” hereinafter also referred to as “character cycling mode” or “special characters mode.” The duration required to initiate character cycling is hereinafter also to as the “threshold duration for character cycling,” “threshold duration for character cycling mode,” or simply “threshold duration.” In various implementations, the threshold duration may range from 0.2 seconds to 4 seconds, or any suitable duration chosen by the implementer.

Character cycling involves transitioning through a sequence of character options associated with the character key. This sequence, which includes both the original keyboard character and any associated special characters (such as “¶”, “π”, “Φ”, “∝”, “\textcircled{P}”, and “p”), continues in a repeated manner while the character key remains held down.

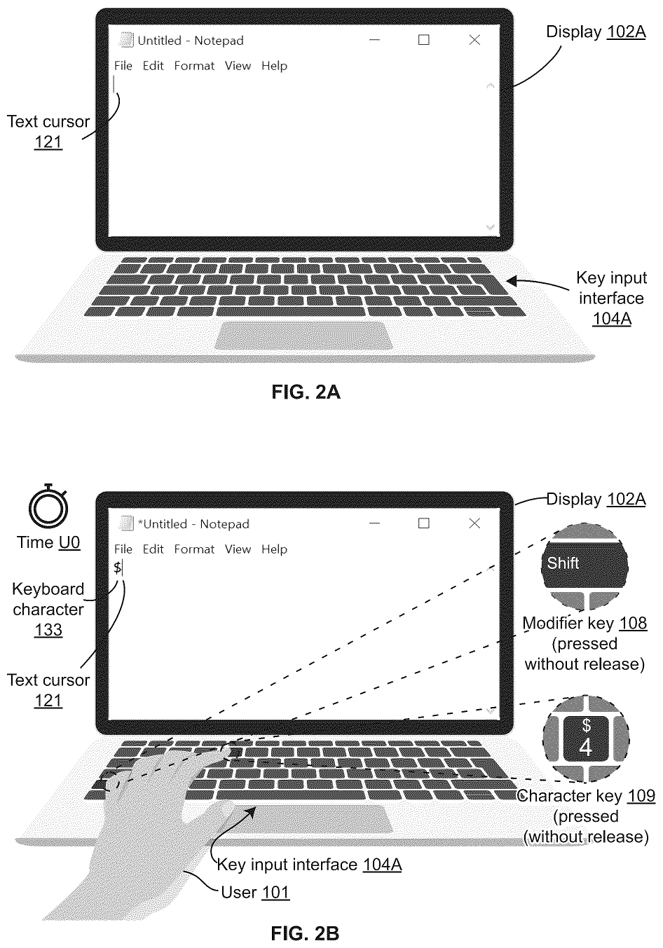

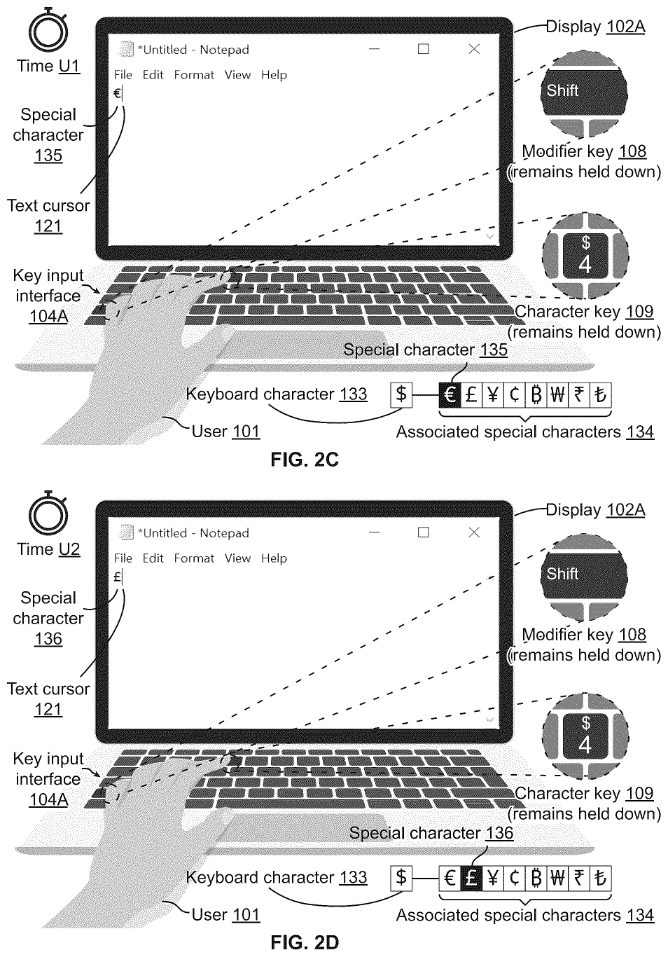

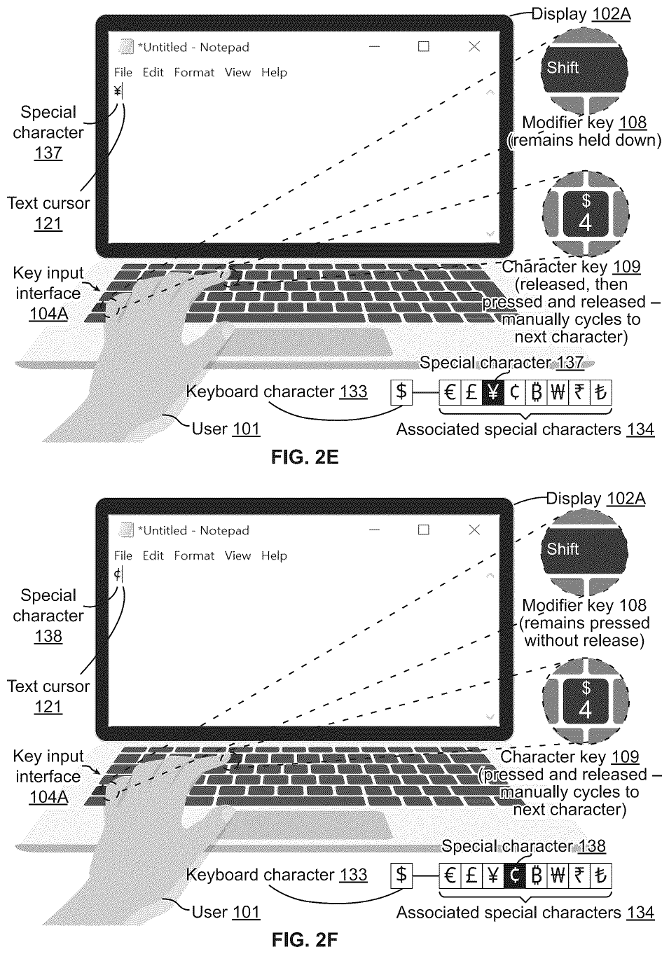

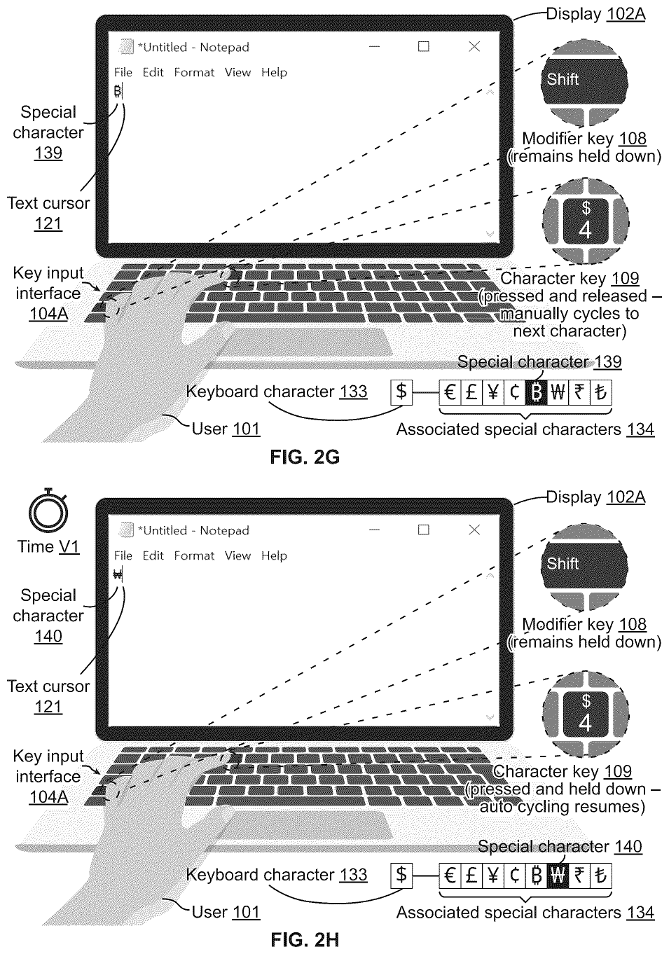

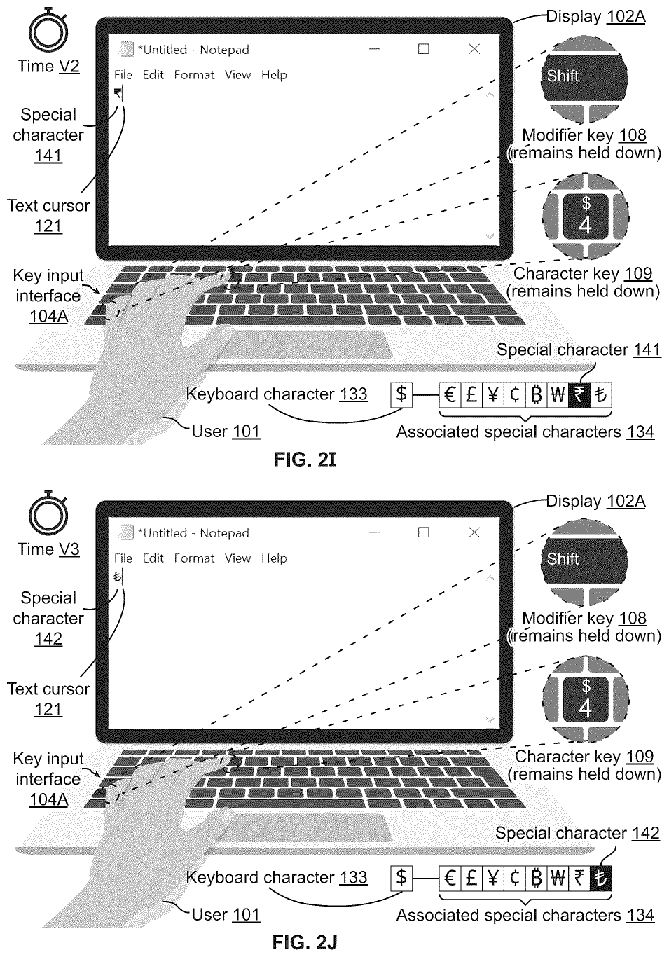

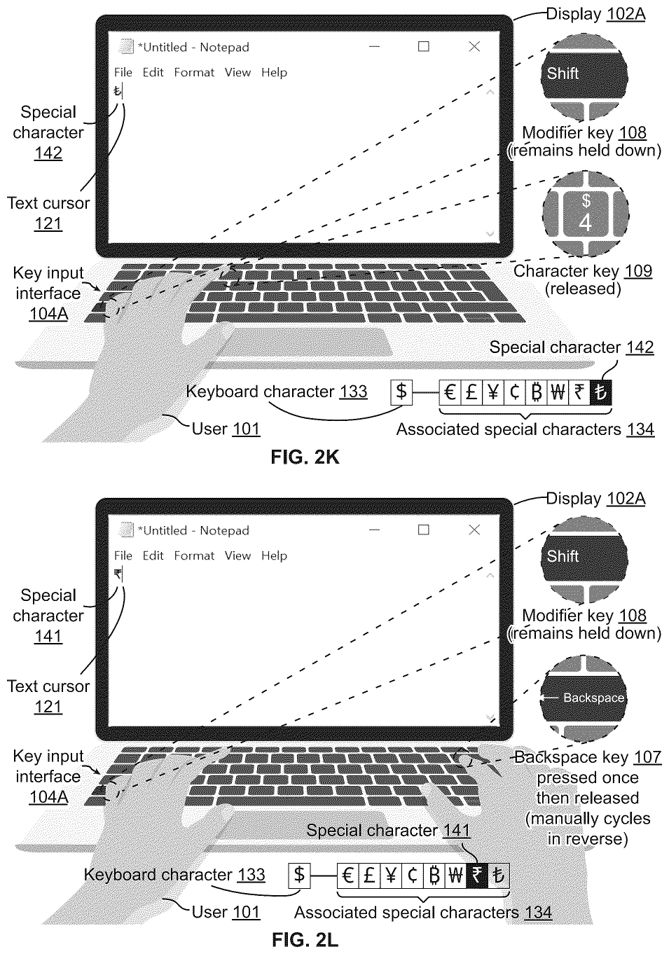

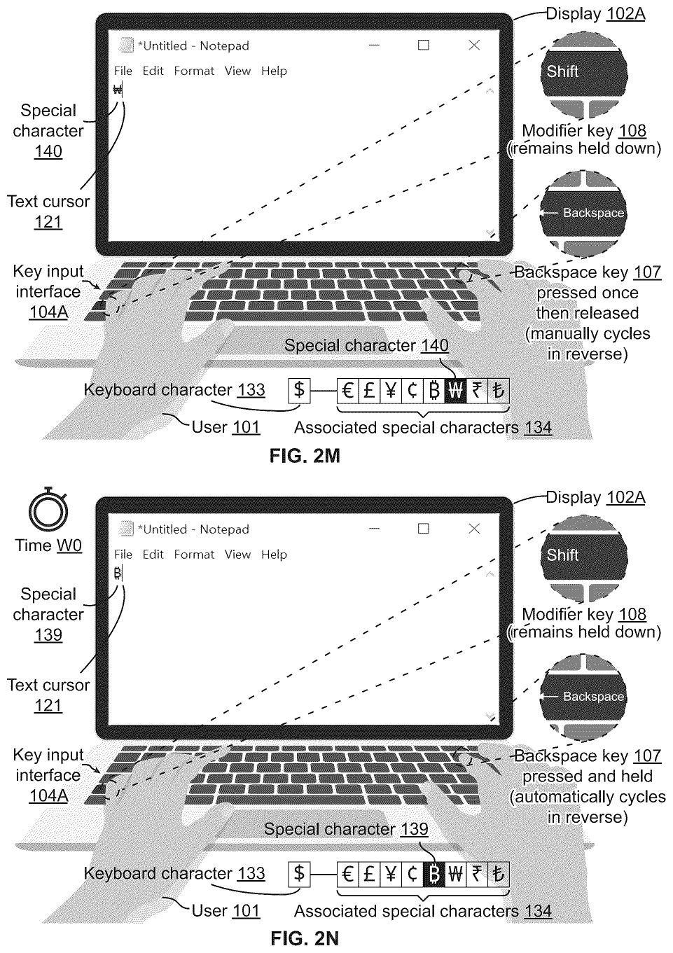

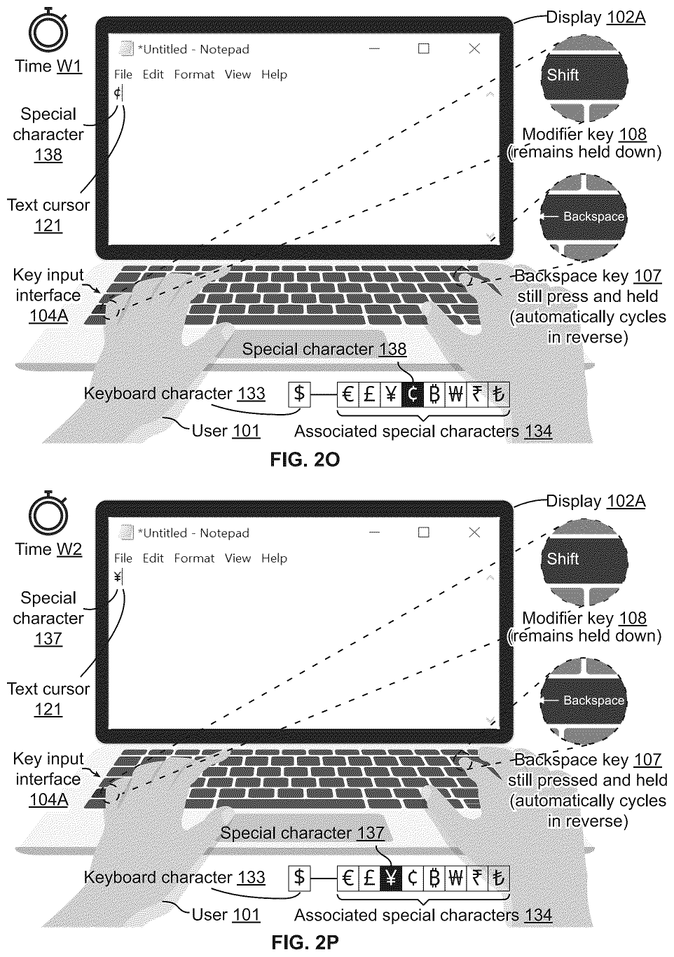

Character cycling can display each character option sequentially in either a forward or backward direction. This sequence progresses automatically, with defined pauses or time intervals between each display. In some implementations, character cycling may be paused by releasing the character key (in the case of a multikey combination disclosed in FIGS. 2A through 2E) or interrupted by the activating manual cycle-forward or cycle-backward functions (which will be explored in FIGS. 1L through IN). Character cycling continues through all character options (such as “¶”, “π”, “Φ”, “∝”, “ [symbol] ”, and “p” in this example) until the sequence is complete, at which point it may return to the initial character and repeat as long as the key is pressed. This repeated cycling is illustrated in FIGS. 1D through 1K.

In other embodiments or implementations, a “character” as described in character cycling mode can represent a broader class of content elements, including but not limited to text strings, images, icons, pictures, or other visual elements associated with the character key.

FIG. 1D (at time T2), following FIG. 1C, illustrates an example display output occurring approximately one second after FIG. 1C (at time T1), during which the user 101 continues to hold down the character key. The previously displayed character (“¶” in FIG. 1C, in this example) is removed, and a second special character (such as special character 126, “π”) from the set of associated special characters (associated special characters 124, in this example) is displayed in its place.

The delay time between T2 and T1 represents a predetermined duration that elapses between each character transition in the automatic cycling sequence of character options. The sequence in this example includes the associated special characters and the original keyboard character (such as associated special characters 124 and keyboard character 123 in this example, i.e., “¶”, “π”, “Φ”, “∝”, “ [symbol] ”, and “p”). This delay is hereinafter referred to as the “automatic cycle interval time” or simply “cycle interval time.” In other words, the cycle interval time defines the pause or delay that occurs before transitioning from one character to the next in the cycling process, as long as the character key remains held down. In various implementations, the automatic cycle interval time may vary, for example, from 0.2 to 4 seconds or any suitable duration chosen by the implementer.

FIG. 1E (at time T3) through FIG. 1K (at time T9), with each figure following sequentially from the previous one, illustrate example display outputs demonstrating the automatic character cycling behavior discussed in FIG. 1D.

FIGS. 1L and 1M, each following sequentially from its predecessor, illustrate a manual cycle forward action that can be triggered at any time during character cycling mode by pressing a Space key on the key input interface (such as Space key 106 in these illustrations). This manual cycle forward function may alternatively be activated using any suitable key, which becomes the designated key for this action. If no alternative key is configured, the Space key serves as the designated key. When the manual cycle forward action is triggered by pressing the designated key, any active automatic cycling is stopped. The function allows users to manually cycle to the next character in the sequence of character options with each press, looping back to the first character in the sequence after reaching the last character, thereby providing enhanced control over character selection. Additionally, automatic cycling in the forward direction (not illustrated) can also be triggered by pressing and holding down the Space key or any designated key.

FIG. 1N, following sequentially from FIG. 1M, illustrates a manual cycle backward action that can be triggered at any time during character cycling mode by pressing a Backspace key on the key input interface (such as Backspace key 107 in this illustration). This manual cycle backward function may alternatively be activated using any suitable key, which becomes the designated key for this action. If no alternative key is configured, the Backspace key serves as the designated key. When the manual cycle backward action is triggered by pressing the designated key, any active automatic cycling is stopped. The function allows users to manually return to the previous character in the sequence of character options with each press, looping back to the last character in the sequence after reaching the first character, thereby providing enhanced control over character selection. Additionally, automatic cycling in the reverse direction (not illustrated) can also be triggered by pressing and holding down the Backspace key or any designated key.

Referring now to FIG. 2A, this figure is similar to FIG. 1A but illustrates the use of a modifier key in conjunction with a character key within a new series of illustrations, beginning with FIG. 2B, each flowing sequentially from the previous one. In prior art, modifier keys such as Shift and AltGr (Alternative Graphic) are commonly used to capitalize letters or access multicharacter keys.

FIG. 2B (at time U0) illustrates an example display output immediately after a user (such as user 101 in this example) simultaneously presses down a modifier key and a character key (such as modifier key 108 [Shift key] and character key 109 [4/$ key] in this example) on the key input interface 104A. A keyboard character (such as keyboard character 133, “$”, in this example) is displayed, and the text cursor 121 advances one character position from its location in FIG. 2A to its new location in this figure, demonstrating prior art behavior.

FIG. 2C (at time U1), following FIG. 2B, illustrates an example display output that occurs when the key down threshold for character cycling is reached, meaning that the duration U1-U0 is equal to or greater than the threshold duration, during which user 101 continues to hold down both the modifier key and character key (such as modifier key 108 and character key 109 in this example). The previously displayed character (“$” in FIG. 2B, in this example) is removed, and a first special character (such as special character 135, “€”) from a set of character options (associated special characters 134 and keyboard character 133 in this example) is displayed in its place.

FIG. 2D (at time U2), following FIG. 2C, illustrates an example display output that occurs at the next character transition in character cycling mode, during which user 101 continues to hold down the character key. The interval U2-U1 represents the character cycle interval time. The previously displayed character (“€” in FIG. 2C, in this example) is removed, and a second special character (such as special character 136, “£”) from the set of associated special characters (such as associated special characters 134), is displayed in place of the removed character.

FIGS. 2E through 2G, each following sequentially from its predecessor, illustrate an additional way of triggering the manual cycle forward function, which may be used alongside the method using the Space key described in FIG. 1L. In this approach, the manual cycle forward function can be triggered by pressing and releasing the character key while continuing to hold down the modifier key. This function allows users to manually advance to the next character in the sequence of character options with each press and release of the character key, providing versatile control.

FIG. 2H through 2J, each following sequentially from its predecessor, illustrate an additional method for switching back to automatic character cycling in the forward direction, which may be used alongside the method of pressing and holding the Space key as discussed in connection with FIGS. 1L and 1M. In this approach, automatic character cycling in the forward direction can be triggered by pressing and holding down the character key (such as character key 109 in this example) while continuing to hold down the modifier key (such as modifier key 108 in this example).

FIGS. 2K through 2M, each following sequentially from its predecessor, illustrate the manual cycle backward function, similar to the method discussed in connection with FIG. 1N, where the function is triggered by pressing and releasing the Backspace key on the key input interface (such as Backspace key 107 in this example) while continuing to hold down the modifier key. This function allows users to manually return to the previous character in the sequence of character options with each press and release of the Backspace key, providing versatile control.

FIGS. 2N through 2P, each following sequentially from its predecessor, illustrate automatic cycling in the reverse direction, which can be performed by pressing and holding down the Backspace key on the key input interface (such as Backspace key 107 in this example). This behavior, similar to the method discussed in connection with FIG. 1N, allows automatic cycling through the sequence of character options in reverse order as long as the Backspace key remains held. Alternatively, this function may be activated using any other designated key, as chosen by the implementer, providing flexibility in key assignment.

The foregoing illustrations illustrate character cycling, which may be automatic or manual and interchangeable. This flexibility allows users to interchange between manual and automatic cycling modes as desired, without being limited to the order shown in the illustrations, thereby providing versatile control over character selection.

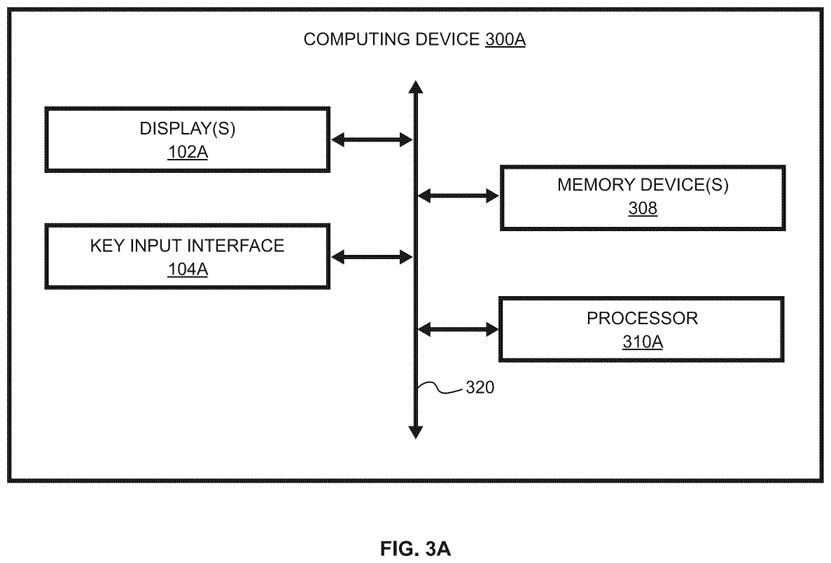

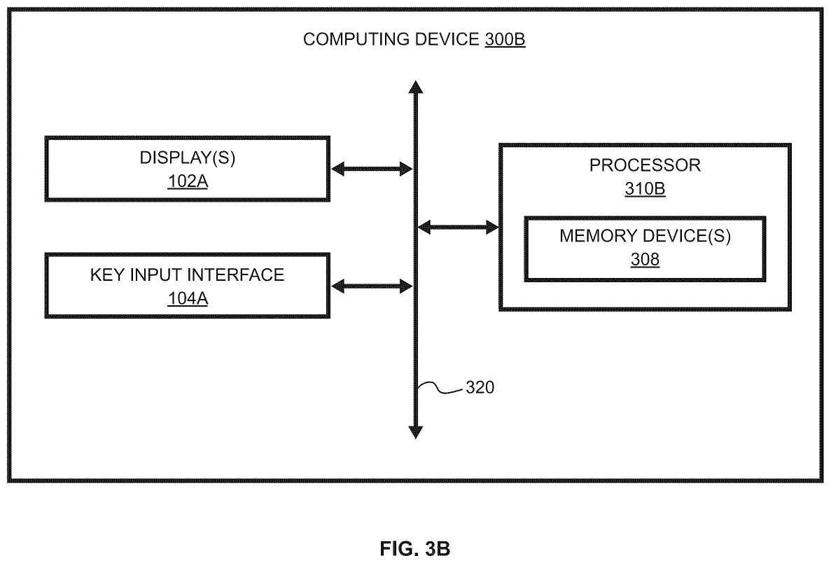

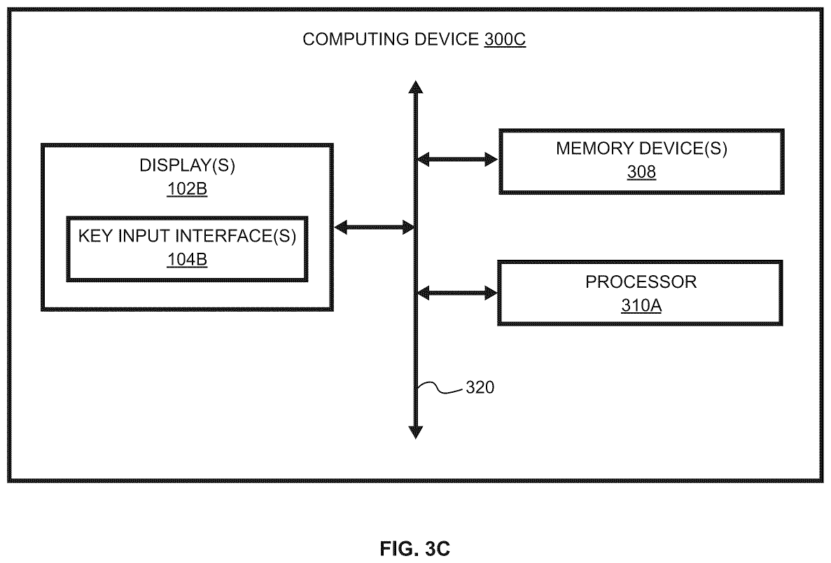

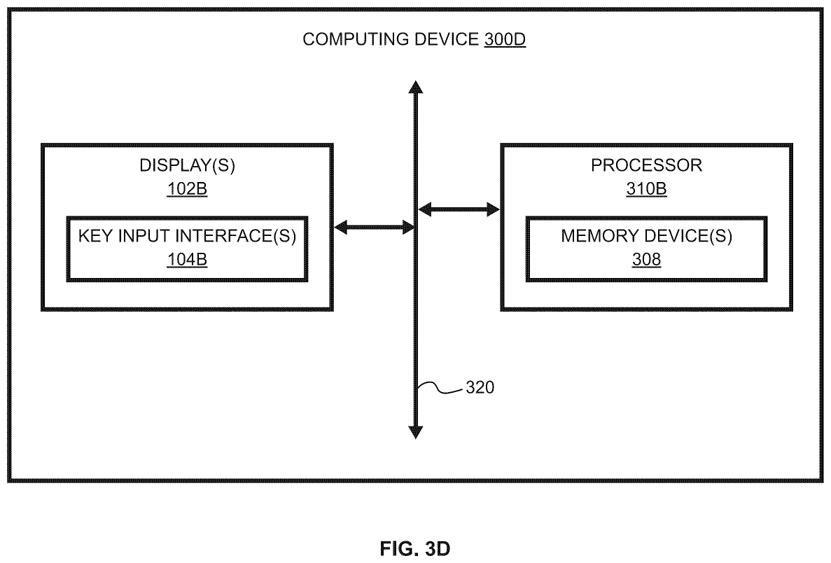

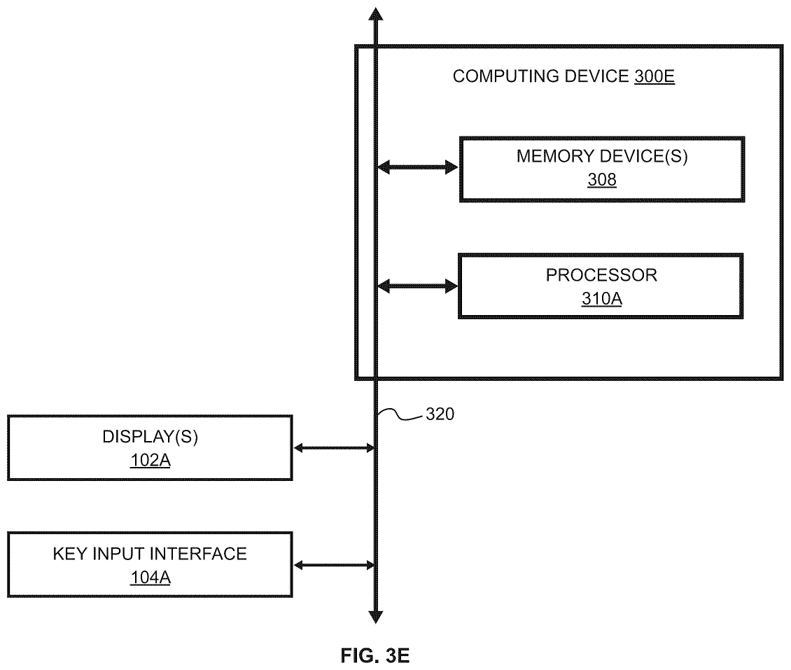

Referring now to FIGS. 3A-3E, FIGS. 3A through 3E present block diagrams depicting different embodiments of a computing device 300A, a computing device 300B, a computing device 300C, a computing device 300D, and a computing device 300E, respectively. Each of these computing devices is configured, at least, to display a special character at a text cursor when a character key is press and held for a duration that meets or exceeds a predefined threshold, further cycling the character through a plurality of characters associated with the key until the user releases the key. As discussed herein, the computing devices 300A, 300B, 300C, 300D, and 300E may simply be referred to individually or collectively as, computing device(s) 300.

A computing device 300 may include any suitable computing system or device currently known or developed in the future, which may also be referred to generally as an information handling device. Examples of computing device 300 include, but are not limited to, a laptop, desktop computer, workstation, tablet, slate, smartphone, cellular phone, personal digital assistant (PDA), wearable device (e.g., smartwatch, smart ring, fitness tracker), Internet of Things (IoT) device, smart television (e.g., Internet-connected TV), game console, onboard vehicle computer, streaming device, smart device, digital assistant, ultra-mobile PC, mobile station, entertainment appliance, digital media player, and microconsole, among other potential computing devices considered herein.

At least in the embodiment illustrated in FIG. 3A, a computing device 300A includes, among other components, one or more display devices 102A (or display(s) 102A), one or more key input interface 104A, a set of memory devices 308 (or memory 308), and at least one processor 310A coupled to and/or in communication with one another via a bus 320 (e.g., a wired and/or wireless bus). At least in the embodiment illustrated in FIG. 3B, a computing device 300B includes, among other components, one or more displays 102A, one or more key input interface 104A, a set of memory devices 308, and at least one processor 310B coupled to and/or in communication with one another via a bus 320. Alternative to the processor 310A in the computing device 300A, the processor 310B in the computing device 300B includes the memory device(s) 308 in the processor 310B, whereas the memory device(s) 308 of the computing device 300A is/are separate and/or independent of the processor 310A. At least in the embodiment illustrated in FIG. 3C, a computing device 300C includes, among other components, one or more displays 102B, one or more key input interface 104B, a set of memory devices 308, and at least one processor 310A coupled to and/or in communication with one another via a bus 320. Alternative to the display 102A in the computing device 300A, the display 102B in the computing device 300C includes the key input interface 104B in the display(s) 102B, whereas the key input interface 104A of the computing device 300A is/are separate and/or independent of the display(s) 102A. At least in the embodiment illustrated in FIG. 3D, a computing device 300D includes, among other components, one or more displays 102B, one or more key input interface 104B, a set of memory devices 308, and at least one processor 310B coupled to and/or in communication with one another via a bus 320. Alternative to the display 102A in the computing device 300B, the display 102B in the computing device 300D includes the key input interface 104B in the display(s) 102B, whereas the key input interface 104A of the computing device 300B is/are separate and/or independent of the display(s) 102A. As discussed herein, the processors 310A and 310B may simply be referred to individually or collectively as, processor(s) 310. Similarly, the displays 102A and 102B may simply be referred to individually or collectively as, display(s) 102, and the key input interface 104A and 104B may simply be referred to individually or collectively as, key input interface 104.

At least in the embodiment illustrated in FIG. 3E, a computing device 300E includes, among other components, a set of memory devices 308, and at least one processor 310A coupled to and/or in communication with one another via a bus 320. Computing device 300E, as opposed to computing devices 300A through 300D, does not incorporate a key input interface or a display in its definition.

A display 102 may include any suitable device, system, hardware, and/or software that is known or developed in the future and is capable of presenting or projecting visual information. It may be integrated into a computing device or exist as an external peripheral, facilitating the presentation or projection of visual elements such as text and graphics. The display may incorporate diverse functionalities that facilitate user interaction, including touch sensitivity, motion sensitivity, augmented reality (AR), and virtual reality (VR) capabilities, allowing for direct interaction with visual elements. Consequently, a display 102 may include a virtual reality keyboard, an augmented reality keyboard, an optical virtual keyboard, or any suitable functionality known or developed in the future that is capable of inputting characters.

A set of memory devices 308 may include any suitable number of memory devices 308. Further, a memory device 308 may include any appropriate type of device and/or system that is known or developed in the future that can store computer-useable code and/or computer-readable code. In various embodiments, a memory device 308 may include one or more non-transitory computer-usable mediums (e.g., readable, writable, readable-writable, etc.), which can consist of any non-transitory and/or persistent apparatus or device that can contain, store, communicate, propagate, and/or transport applications, instructions, data, computer programs, software, code, routines, etc., for processing by or in connection with a computer processing device (e.g., processor 310A and/or processor 310B).

In some embodiments, a memory device 308 comprises volatile computer storage media. For instance, a memory device 308 may consist of random access memory (RAM), which can include dynamic RAM (DRAM), synchronous dynamic RAM (SDRAM), and/or static RAM (SRAM). In other embodiments, a memory device 308 comprises non-volatile computer storage media. For example, a memory device 308 may feature flash memory and/or any other suitable non-volatile computer storage device that is known or developed in the future. In various embodiments, a memory device 308 may include both volatile and non-volatile computer storage media.

A bus 320 refers to a communication system that facilitates the transfer of data between various components within a computing device and/or between the computing device and external components. Buses can be implemented through one or more wired connections known or developed in the future, such as USB or HDMI, or through one or more wireless technologies known or developed in the future, such as Wi-Fi or Bluetooth, enabling data exchange among components, whether integrated or external. A bus 320 encompasses any interconnected set of buses 320 that operate to facilitate data transfer and communication.

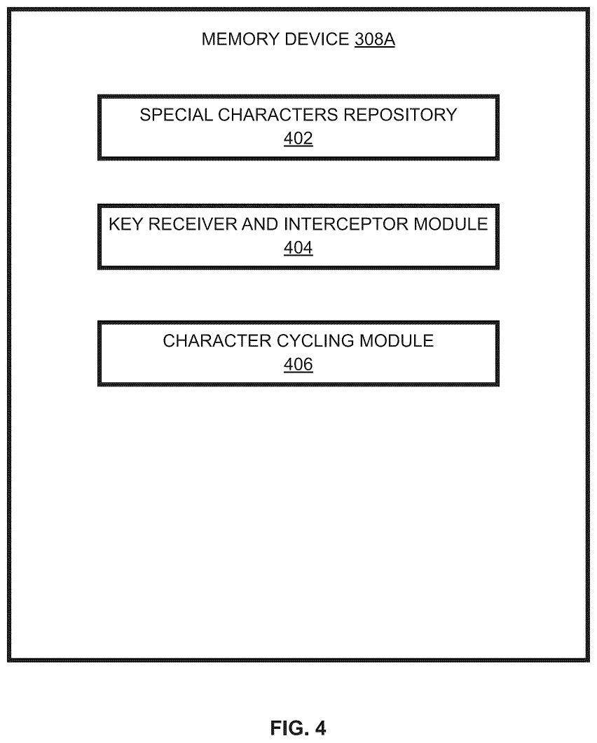

Referring now to FIG. 4, this figure is a schematic block diagram of one embodiment of a memory device 308A. At least in the illustrated embodiment, the memory device 308A comprises, among other components, a special characters repository 402, a key receiver and interceptor module 404, and a character cycling module 406. These components are configured to operate together, when executed by a processor 310, to facilitate the selection and entry of a special character based on key events.

The special characters repository 402 may include any suitable hardware and/or software configured to store data. Accordingly, the special characters repository 402 may include any suitable type of data repository, whether known or developed in the future. This repository may store and represent characters in any suitable encoding format, such as UTF-8 or UTF-16, to ensure compatibility with a wide range of applications and systems.

The special characters repository 402 may be initialized with a collection of special character entries, each entry comprising a special character associated with one or more keyboard characters. For example, an entry might include the special character “x” (multiplication sign) associated with the keyboard characters “*” and “x”, as these characters are commonly used as typographic substitutions for the multiplication sign. This structure enables retrieval of special characters linked to a given keyboard character.

Various methods may be used to associate a keyboard character with a special character. For example, the spelling of the special character may begin with the keyboard character, or the shape or appearance of the special character may resemble that of the keyboard character. Additionally, the special character and the keyboard character may belong to the same use category, serve similar functions, or convey analogous meanings. Other methods of association may include character derivatives or typographical variations. These examples of association are non-limiting and are provided to illustrate possible relationships contemplated herein.

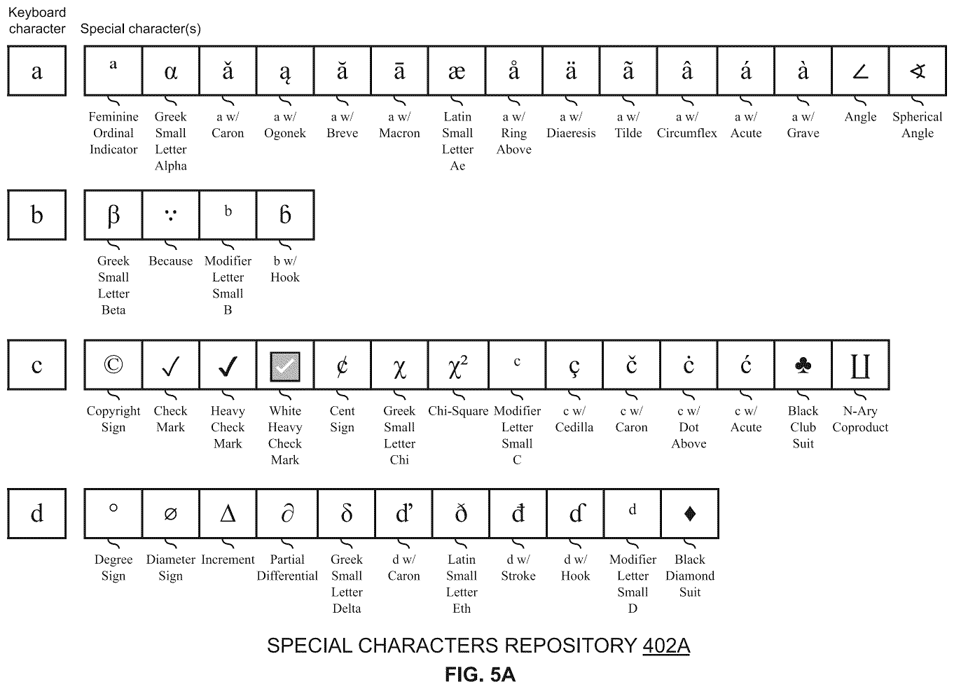

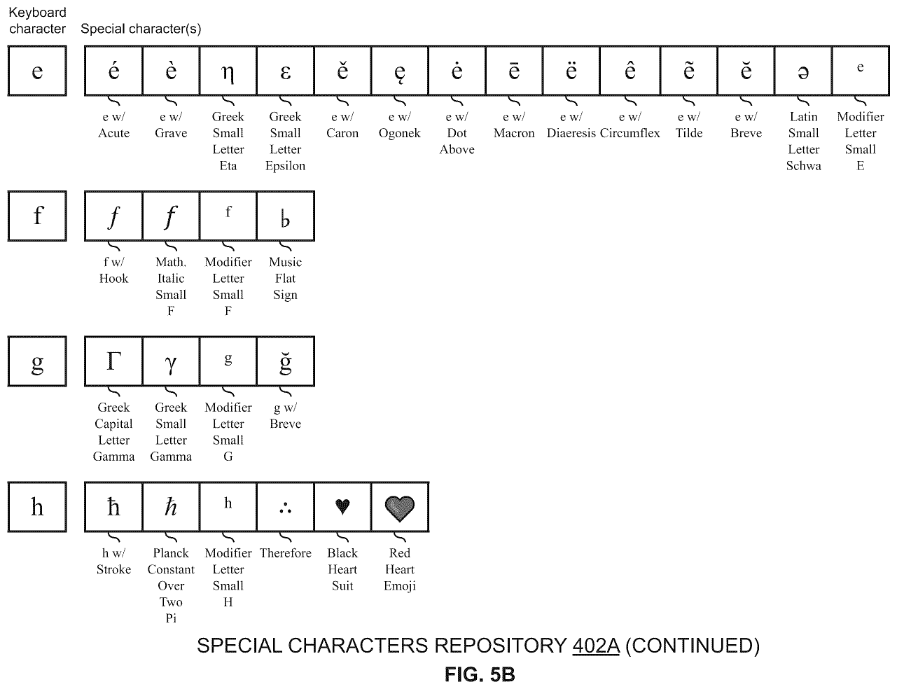

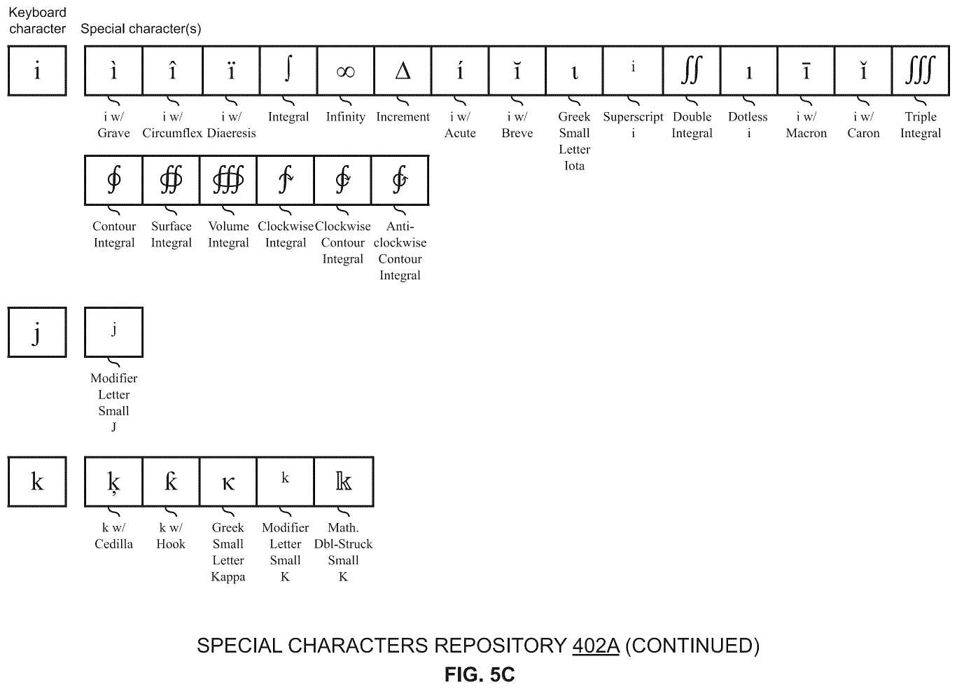

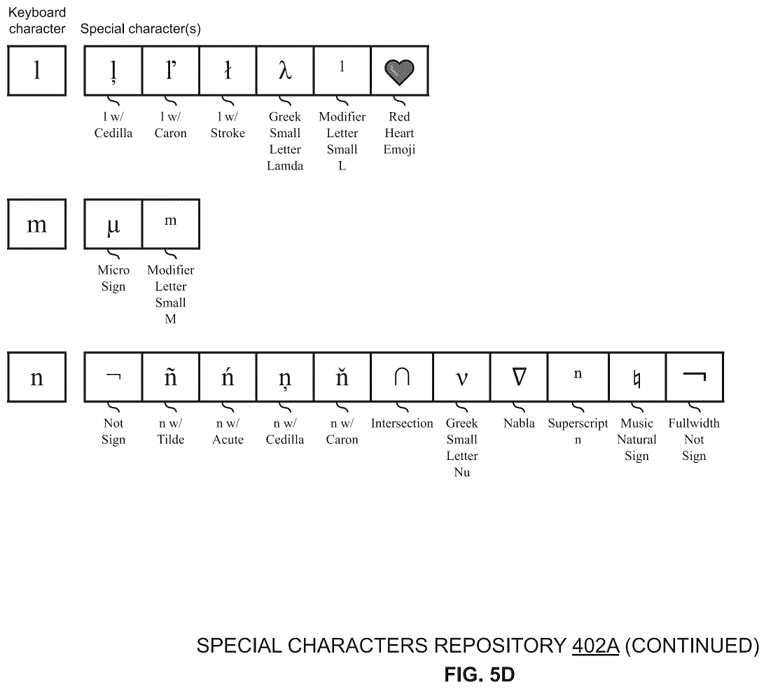

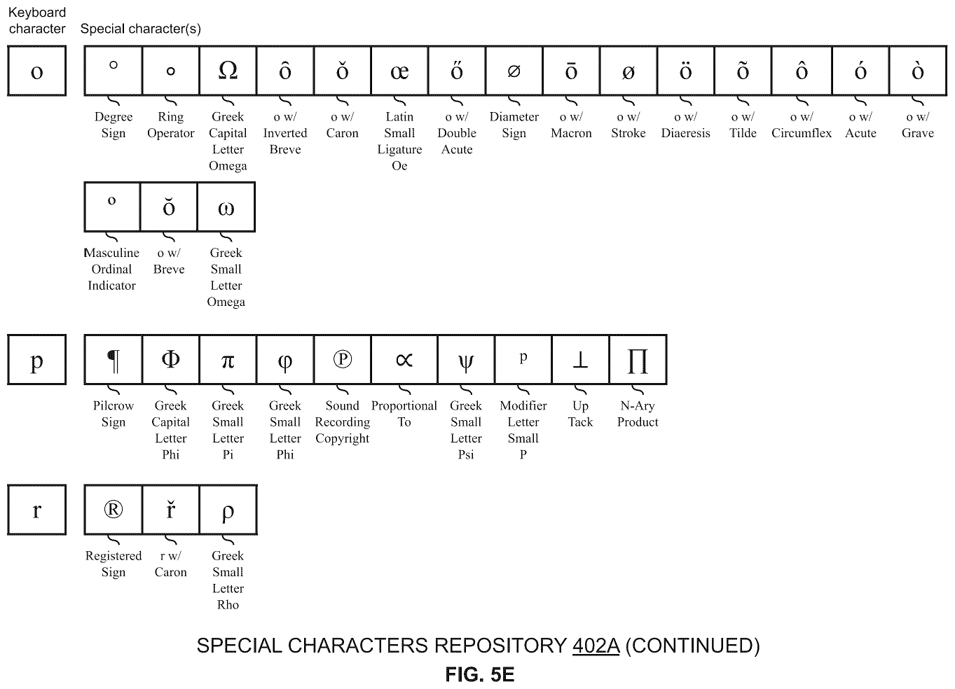

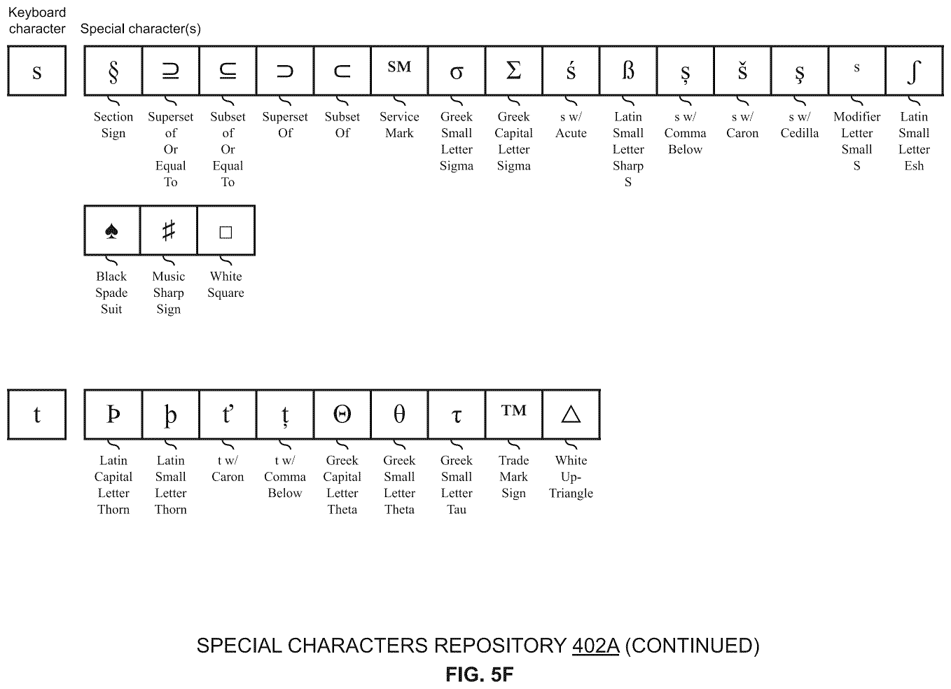

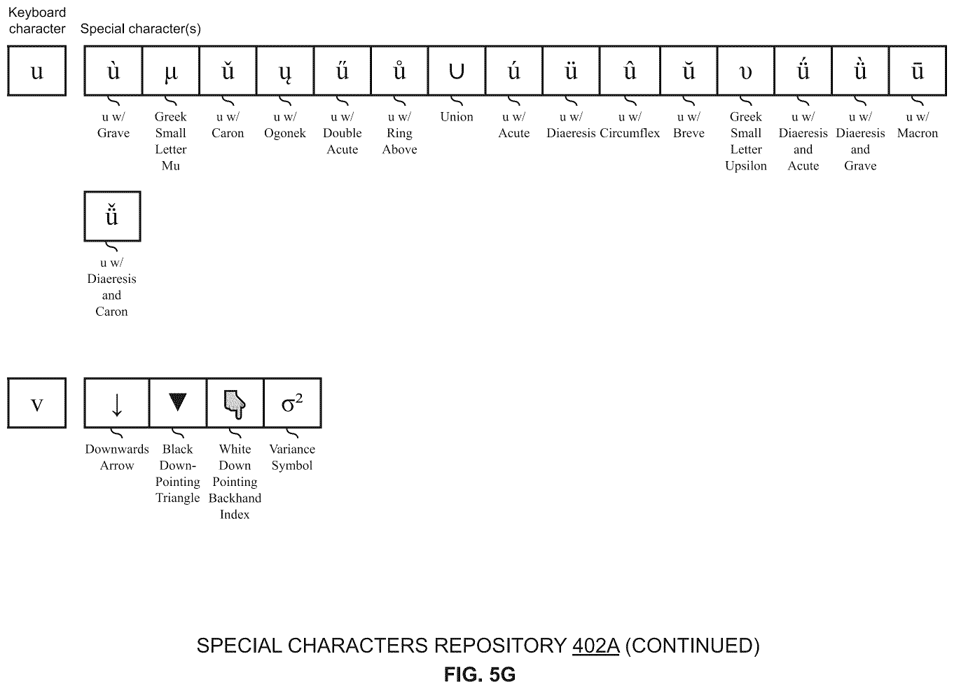

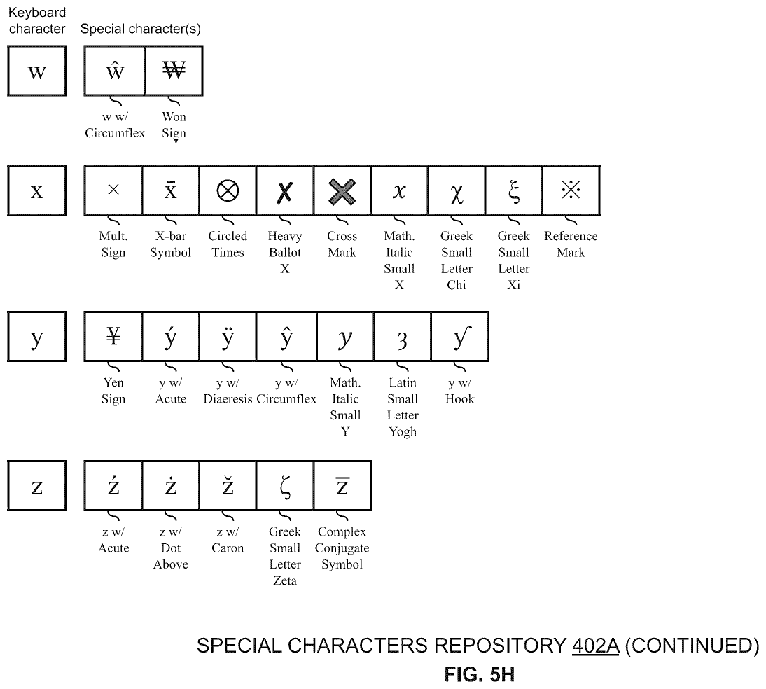

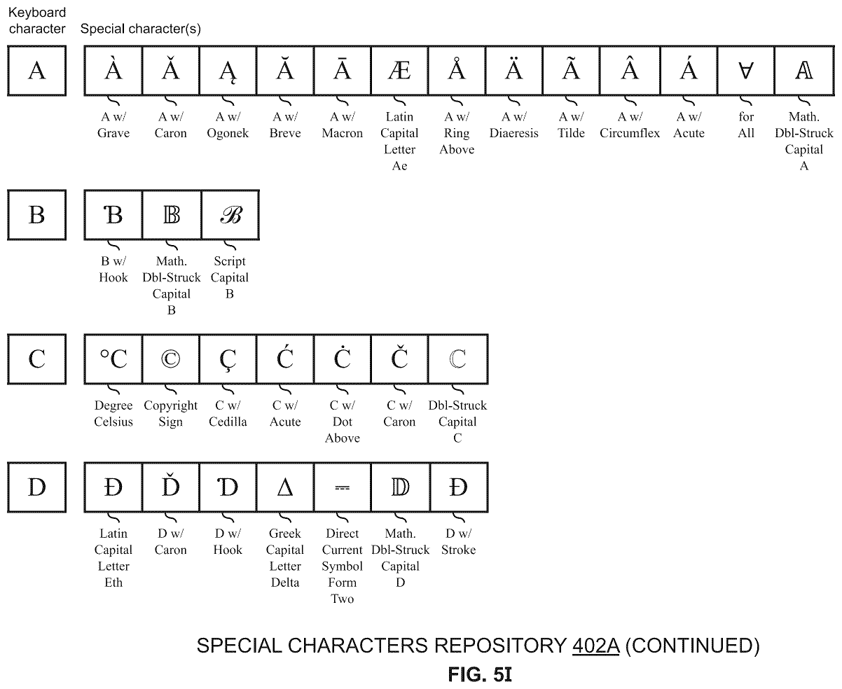

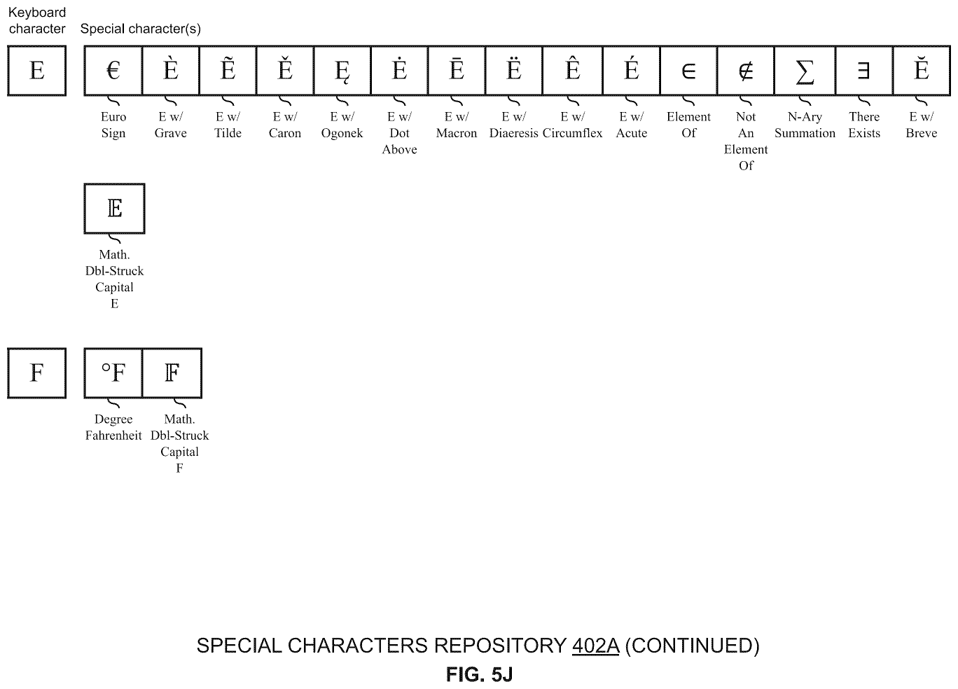

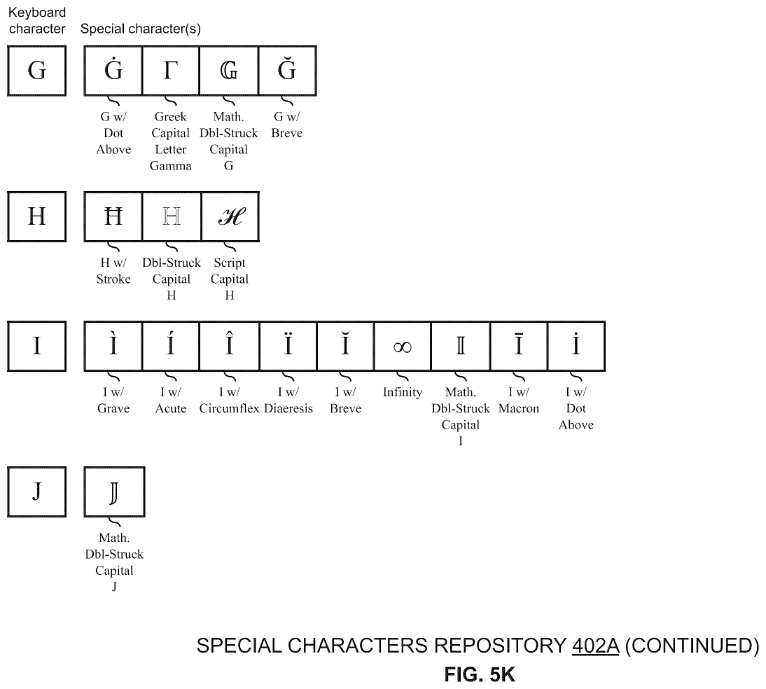

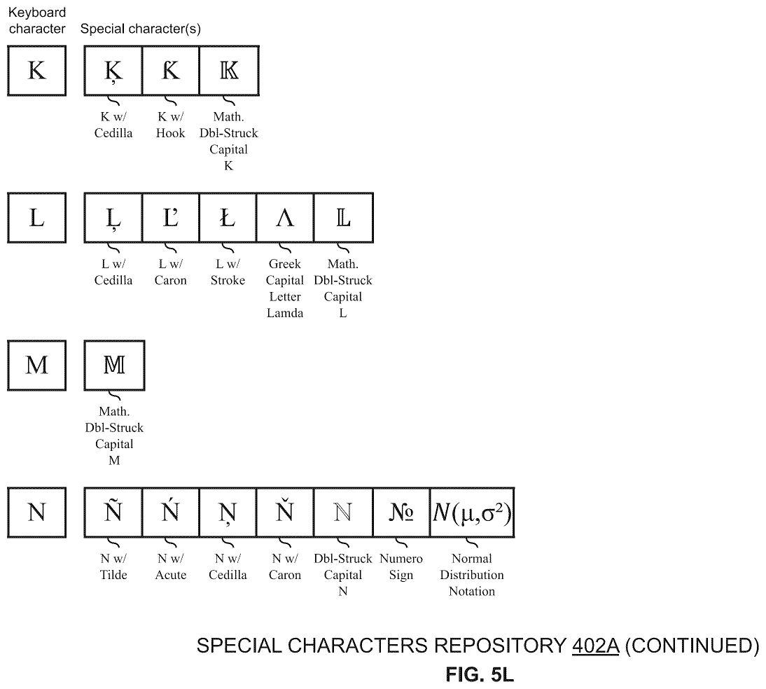

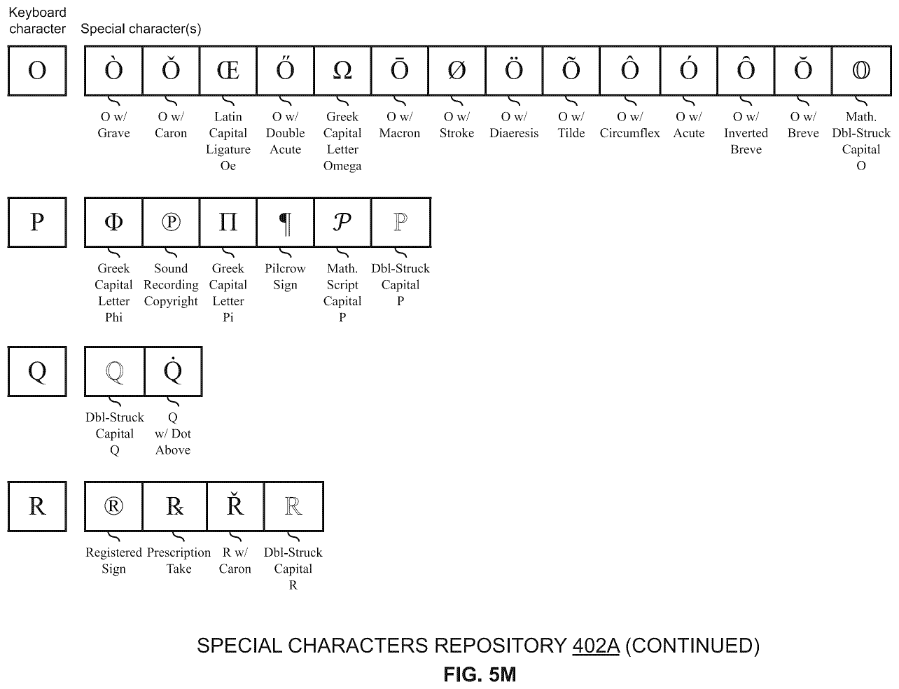

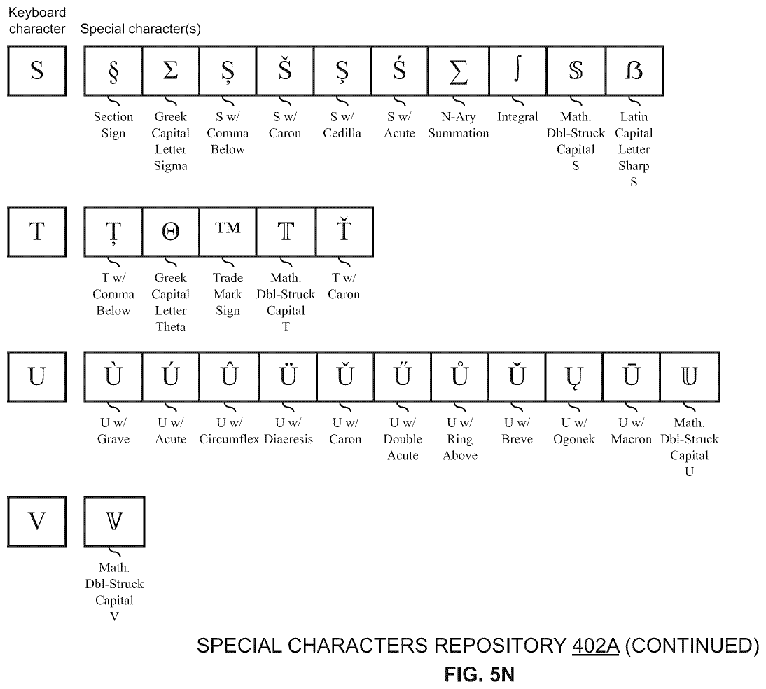

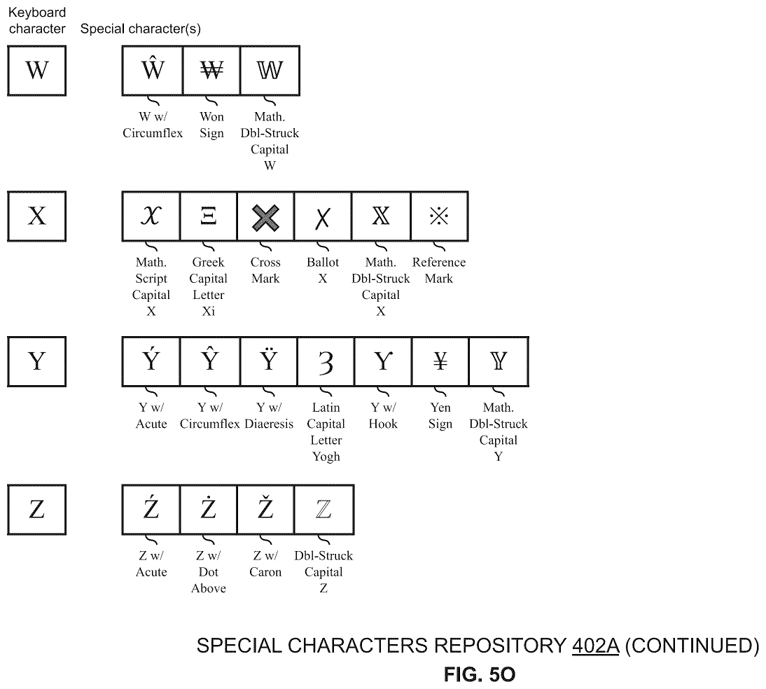

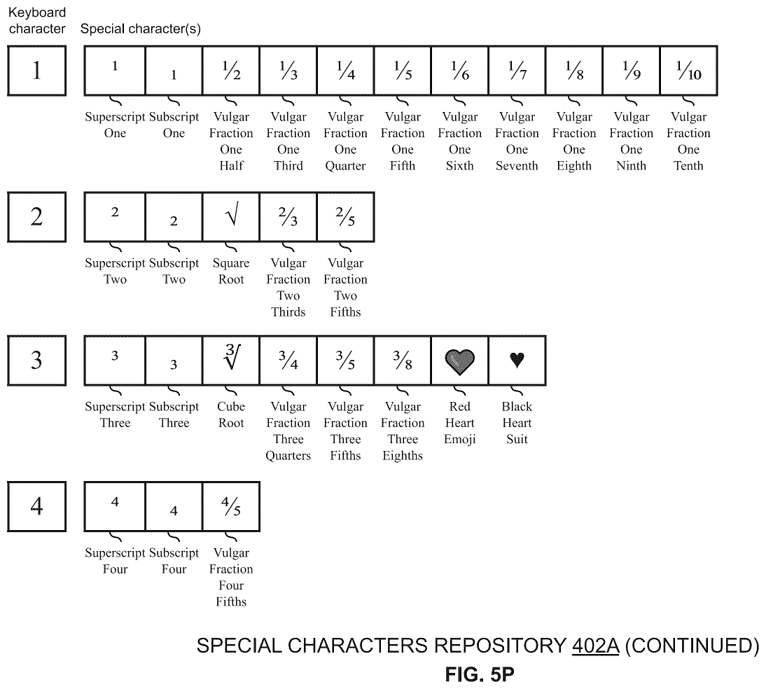

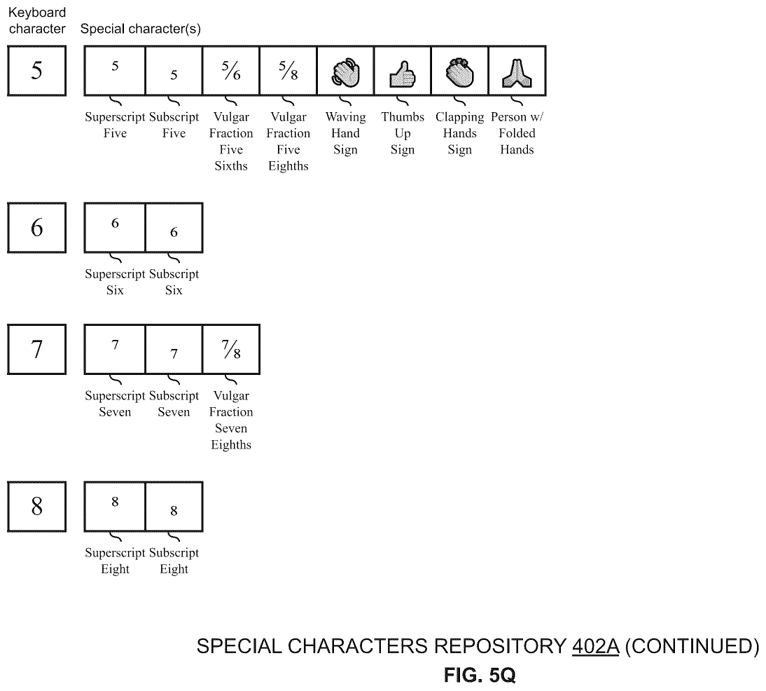

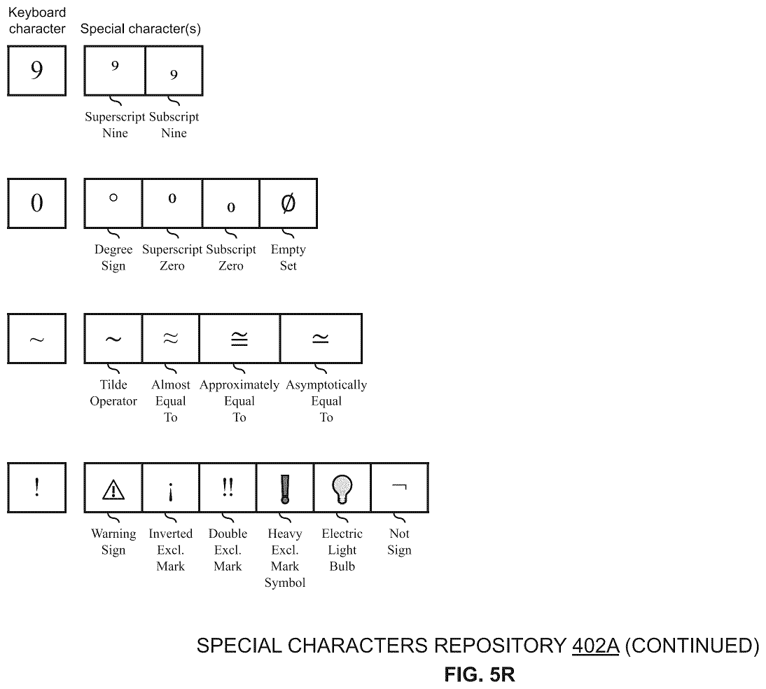

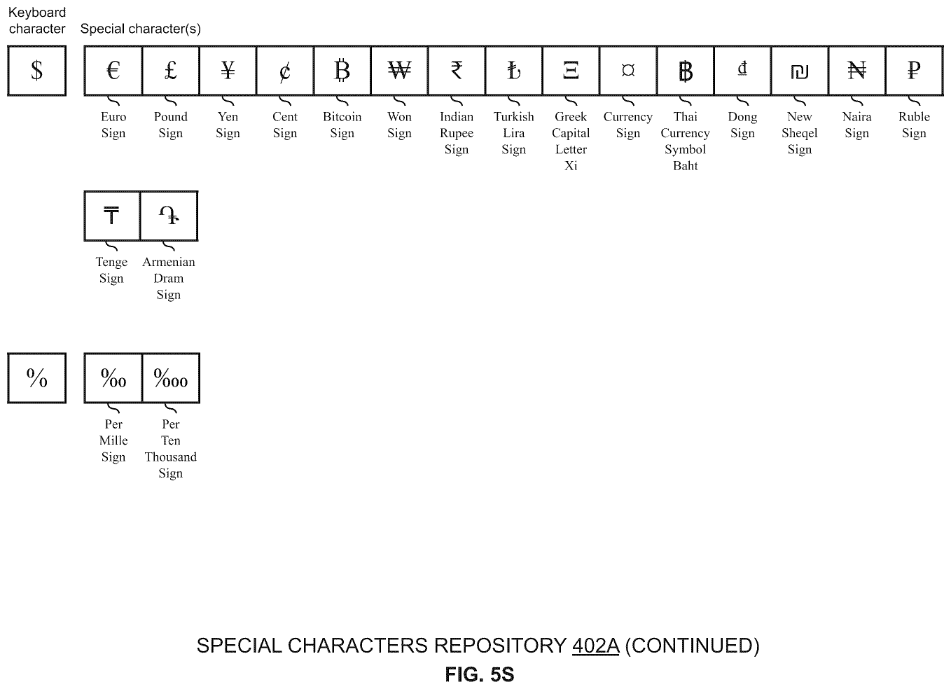

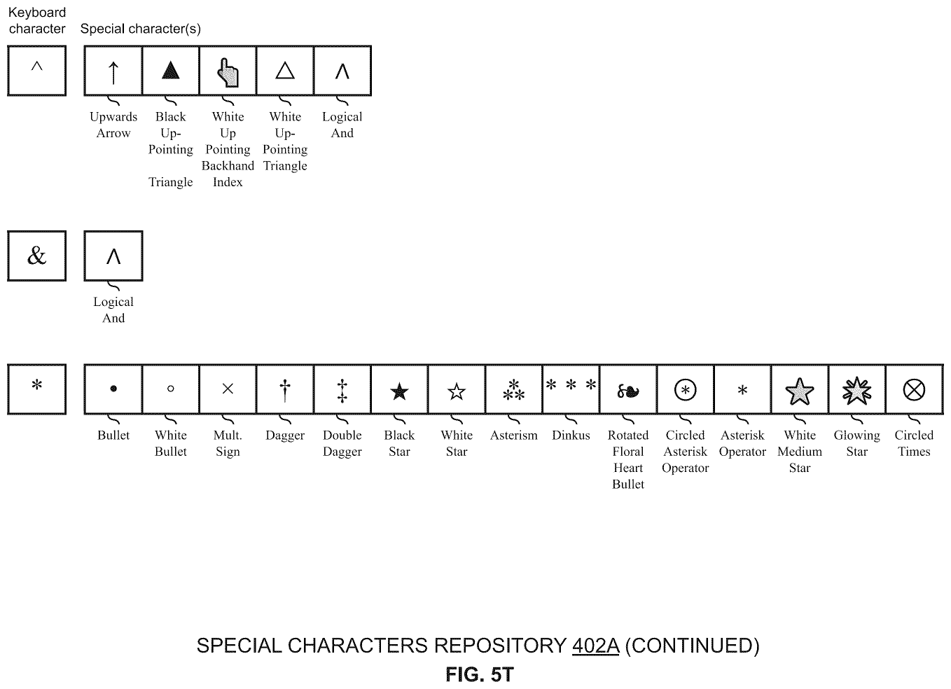

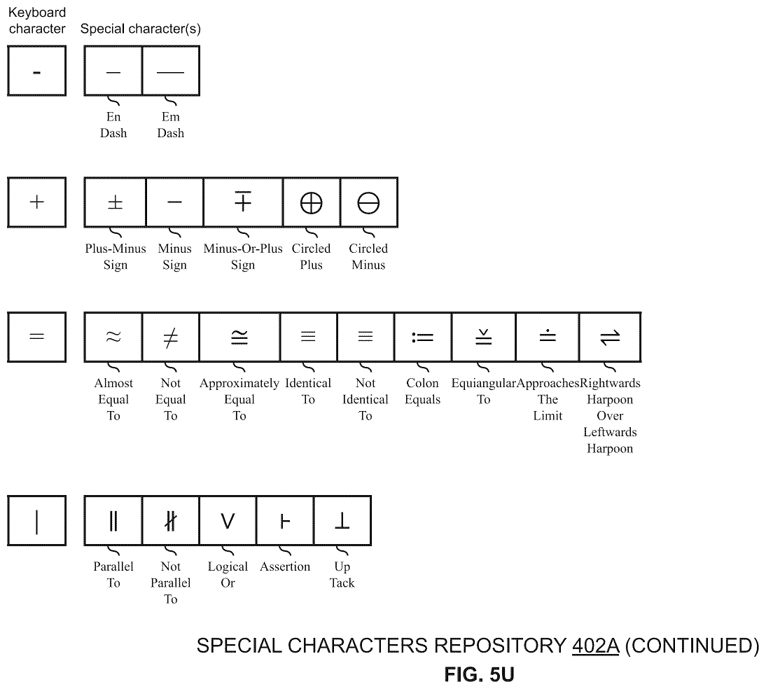

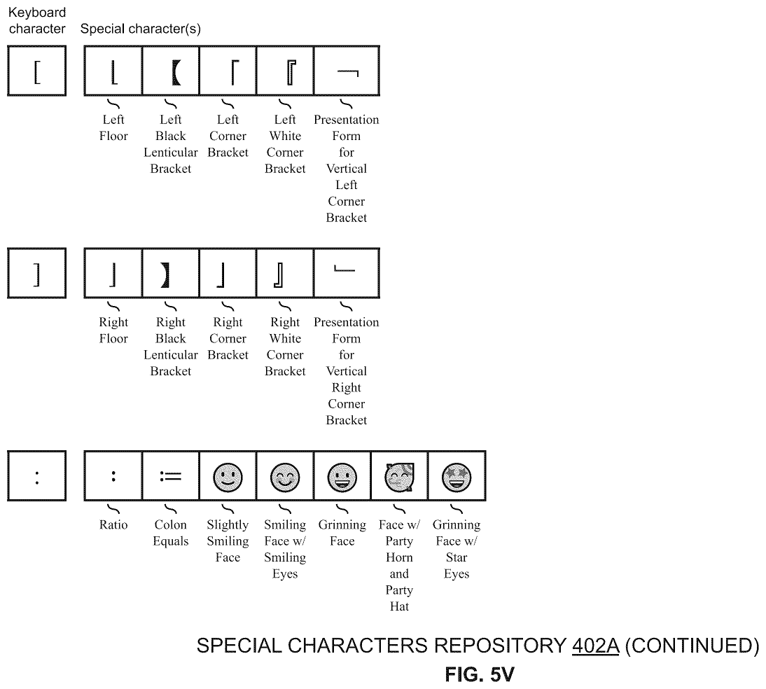

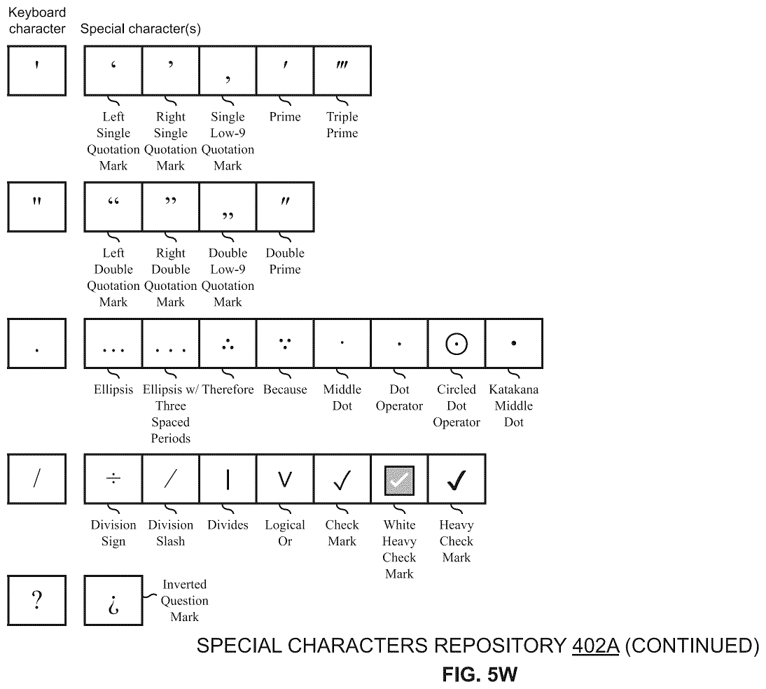

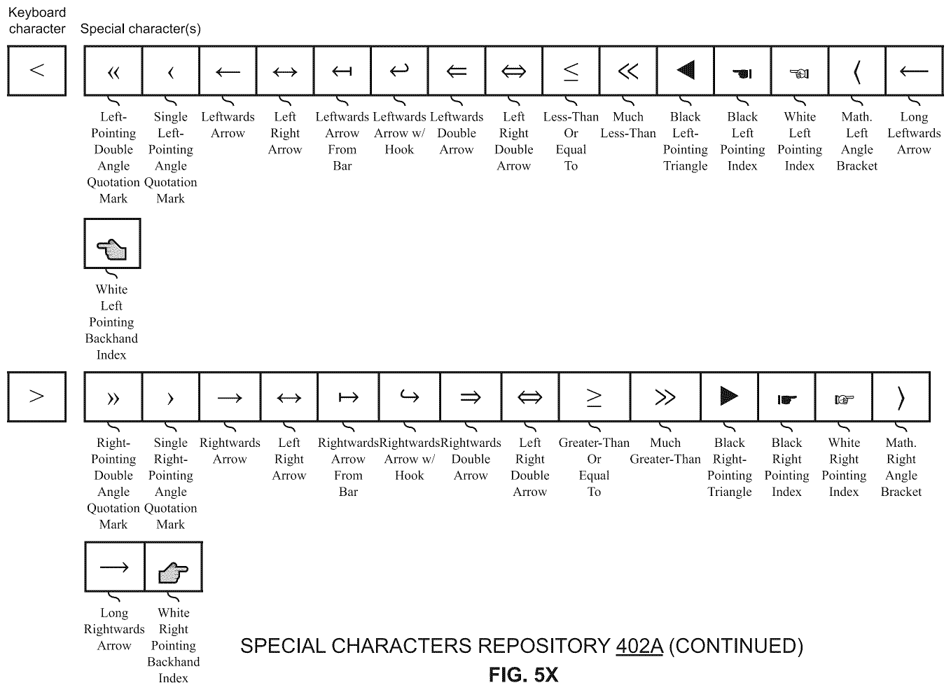

FIGS. 5A through 5X provide a simplified representation of one implementation of the contents of the special characters repository 402. This figure visually exemplify the associations between keyboard characters and special characters, illustrating one possible format for representing such relationships.

For example, as illustrated in FIG. 5C, the special characters ∝ (infinity), ∫ (integral), and Δ (increment) are associated with the keyboard character “i” because the spelling of their names begins with “i.” Similarly, as illustrated in FIG. 5F, superset and subset characters such as [symbol] (superset), [symbol] (subset), ⊃ (proper superset), and ⊂ (proper subset) are associated with the keyboard character “s” because the spelling of their names begins with “s.”

Additional examples, as illustrated in FIG. 5G, include ↓ (Downwards Arrow) and ▾ (Black Down-Pointing Triangle), which are associated with the primary keyboard character “v” due to their visual resemblance and their shared representation of a downward direction through shape and orientation.

Examples of associations based on use category, as illustrated in FIG. 5S, include the keyboard character “$,” which is associated with various currency symbols such as € (Euro Sign), £ (Pound Sign), ¥ (Yen Sign), ¢ (Cent Sign), [symbol] (Bitcoin Sign), [symbol] (Won Sign), [symbol] (Indian Rupee Sign), and [symbol] (Turkish Lira Sign). Additionally, as illustrated in FIG. 5V, the keyboard character “[” is associated with various other characters such as the left floor character, left black lenticular bracket, left corner bracket, left white corner bracket, and vertical left corner bracket, among others, representing related brackets and separators.

Examples of typographical variant associations include “a” and “^{a}” (feminine ordinal indicator), as well as “1” and its variants “¹” (superscript one) and “₁” (subscript one).

Examples of character derivative associations include “½” (one-half), “¼” (one-quarter), and “⅓” (one-third), which are associated with “1” as they represent modifications, variations, or extensions of “1” to depict fractions or other numerical relationships conceptually linked to the number.

As an example of associations based on analogous meaning, the characters ˜ (similar to), ≈ (approximately equal to), ≅ (congruent to), and ≃ (asymptotically equal to) are associated with the tilde (“˜”) because they convey similar concepts in certain contexts.

It is important to note that these illustrations are not intended to be limiting. It will be evident to those skilled in the art that various configurations and implementations of the special characters repository, or portions thereof, may be realized without departing from the scope of the invention.

The key receiver and interceptor module 404 is configured to monitor, intercept, process, and respond to keystrokes generated by the key input interface 104.

In some embodiments, the key receiver and interceptor module 404 may interface directly with keyboard hardware, receiving raw input signals and converting them into a format suitable for processing. In certain implementations, the key receiver and interceptor module 404 may function as an operating system component, such as a kernel module, or operate at a low level within the operating system to intercept and respond to keyboard events (key presses and releases) before these events are delivered to other applications. Additionally, in other embodiments, the key receiver and interceptor module 404 may be implemented by registering event listeners with the operating system's event handling framework, application programming interface (API), or runtime environment (e.g., the Windows SetWindowsHookEx API, macOS Carbon framework, or JavaScript EventTarget interface) to capture keyboard events.

The key receiver and interceptor module 404 includes event listeners configured to capture keyboard events, such as key presses and releases. It also includes functionality to detect long key presses, referred to as a press-and-hold gestures. Additionally, the module facilitates the sending of simulated keystrokes, enabling it to programmatically produce key press and release events. This capability allows the module to mimic user input and automatically output characters, thereby expanding the text entry capabilities of the key input interface 104.

Press-and-hold detection may be accomplished by monitoring the duration of a key press. Upon the initial activation of a key, a timer is initiated to track the elapsed time. If the key remains engaged for a duration equal to or exceeding a predefined threshold, the key receiver and interceptor module recognizes this condition as a press-and-hold gesture. Upon detecting such a gesture, the module may execute specific actions associated with it, such as triggering a repeat function for the key or initiating an alternate action, depending on conditions described in further detail below. Conversely, if the key is released before the threshold is met, the module processes the input as a standard key press without any special gesture implications. The predefined threshold duration may be user-configurable.

In certain embodiments, upon detecting a keystroke, the key receiver and interceptor module may perform scan code to character translation, converting the low-level scan code generated by the keyboard hardware into a corresponding character value.

In various embodiments, upon detecting a key press, the key receiver and interceptor module may first translate a scan code into a virtual-key code, which can be performed using functions commonly available in various operating systems. This conversion from scan code to virtual-key code preferably accounts for the current keyboard layout. The module then translates the virtual-key code, in conjunction with the current keyboard state-including the toggle or press state of modifier keys such as Shift, Ctrl, Alt, and AltGr-into the corresponding character. This approach ensures accurate character translation, as the same key can produce different characters depending on the active state of the modifier keys and/or active keyboard layout. The translation process may utilize functions such as Map VirtualKeyEx and ToUnicodeEx in Windows, or equivalent functions available in macOS through frameworks such as Carbon; these are provided as non-limiting examples.

Upon detecting the release of a key, the previously activated timer is deactivated and removed. Simultaneously, a key-up event is dispatched to ensure that the key release is communicated to the appropriate processing entities. This action confirms that the key receiver and interceptor module does not suppress the key-up event, thereby allowing relevant entities, such as the operating system or applications, to respond appropriately to the key release. The removal of the timer ensures that ongoing monitoring of the key press duration is halted, preventing any erroneous triggering of actions associated with a press-and-hold gesture. This allows the key receiver and interceptor module to handle subsequent key events without interference from the prior key press.

In various embodiments, the key receiver and interceptor module 404 may include a logging mechanism configured to record user input events for contextual analysis or other suitable purposes contemplated herein.

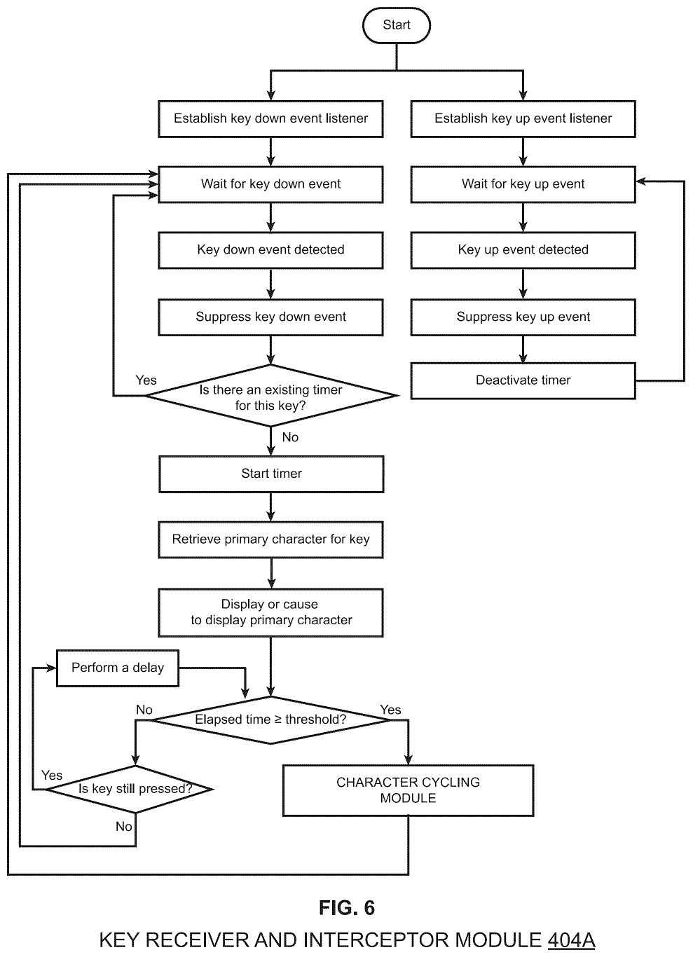

FIG. 6 is a schematic flowchart diagram illustrating the flow of operations within one implementation of a key receiver and interceptor module. The module is designed to detect whether a key has been pressed and held for a specified duration threshold. If this condition is met, the system transitions to a subsequent processing phase referred to herein as character cycling.

The process begins with the establishment of a key down listener and a key up listener to monitor key down and key up events. After initialization, the system enters a state where it concurrently monitors these events, enabling continuous tracking of user input. Upon detecting a key down event, the system checks for the existence of a timer associated with the pressed key. This timer may be linked to a unique identifier for the key, such as the keyboard character, scan code, or any other identifier that distinctly represents the key. If no timer exists, indicating that this is the first press of the key and that it has not been previously pressed and held, the system initiates a timer associated with the key, retrieves the character corresponding to the key (e.g., the keyboard character), and outputs or displays that character. The system then evaluates whether the elapsed time of the timer meets or exceeds a predefined threshold. If the threshold is met, the flow transitions to a character cycling module for further processing. Otherwise, the system checks whether the key remains pressed. If the key is no longer pressed, the process loops back to waiting for a key down event. If the key is no longer pressed, the process loops back to monitoring for a key down event. If the key remains pressed, the system continues evaluating whether the elapsed time has reached or surpassed the threshold.

In relation to key up events, upon detecting a key up event, the system deactivates the associated timer and returns to monitoring for key up events.

The character cycling module is configured to replace, or cause the replacement of, the character at a text cursor or input insertion point with a first special character associated with the pressed key. If the key remains pressed beyond a predefined time interval, the first special character is replaced with a second special character. Similarly, if the key remains pressed beyond subsequent predefined time intervals, each successive special character is replaced with the next special character in the sequence. After the last special character in the set is displayed, it is replaced with the keyboard character if the key remains pressed beyond the next predefined time interval. The cycling process then repeats for as long as the key remains pressed.

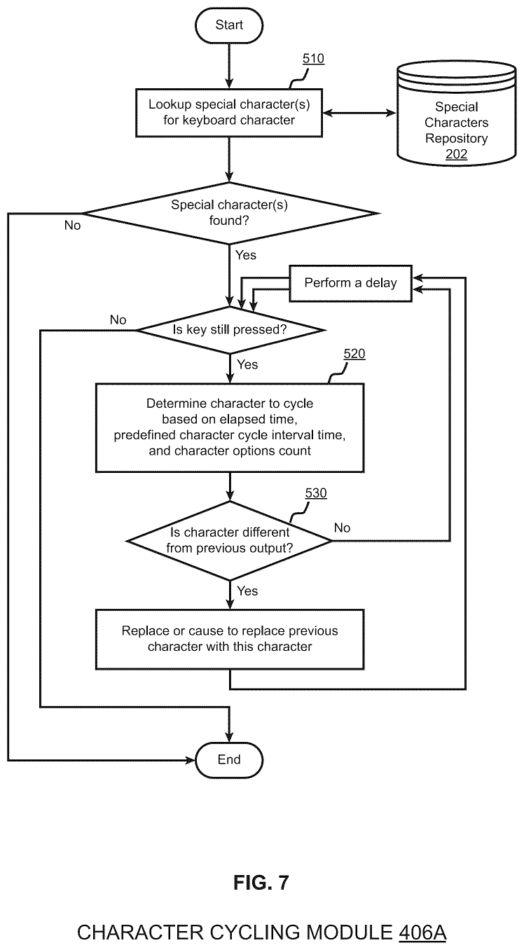

FIG. 7 is a schematic flow chart diagram illustrating one implementation of a character cycling module. At least in the illustrated implementation, the process begins by querying the special characters repository to retrieve special characters associated with a keyboard character (block 510). If the query returns a positive result, indicating the presence of special characters associated with the keyboard character, and if the key remains pressed, the process transitions to the next designated operation (block 520). Conversely, if no special characters are found or if the key is released, the module concludes its operations.

Block 520 determines which character (either from the set of special characters or the keyboard character) should be displayed based on the elapsed time since the character cycling module was triggered, the predefined cycle interval time, and the total number of characters in the sequence (special characters and primary keyboard character). For example, if the keyboard character is “k” and the associated special characters are “κ” (Greek small letter kappa), “^{k}” (modifier letter small k), “ [symbol] ” (Latin small letter k with hook), and “ [symbol] ” (Latin small letter k with cedilla), an array data structure comprising five elements may be initialized in pseudocode as follows: the first element, denoted as characterList[0], is assigned the value “κ”; the second element, characterList[1], is assigned the value “^{k}”; the third element, characterList[2], is assigned the value “ [symbol] ”; the fourth element, characterList[3], is assigned the value “ [symbol] ”; and the fifth element, characterList[4], is assigned the value “k”. The following example in pseudocode describes a process for returning an element given an array of elements, the elapsed time since the character cycling module was triggered (denoted as Te in the pseudocode, which can be calculated by subtracting the press-and-hold threshold duration from the timer's elapsed time), and the cycle interval time (denoted as Ti in the pseudocode).

// Counts the number of elements in array characterList
totalElements = length(characterList)
// Calculate index using floor and modulo operations
i = floor(Te / Ti) mod totalElements
// Return the element at index i from array characterList
Return characterList[i]

The following table summarizes example input values for the variables Ti (cycle interval time) and Te (elapsed time), along with the resulting outputs generated by the pseudocode, given the array data described above.

| Ti (milliseconds) | Te (milliseconds) | Output |
|---|---|---|
| 1000 | 100 | [symbol] |
| 1000 | 1000 | [symbol] |
| 1000 | 2000 | [symbol] |
| 1000 | 3000 | [symbol] |
| 1000 | 4000 | k |
| 1000 | 5000 | [symbol] |
| 1000 | 6000 | [symbol] |
| 1000 | 7000 | [symbol] |
| 1000 | 8000 | [symbol] |
| 1000 | 8500 | [symbol] |
| 1000 | 9000 | k |

It will be understood that the variable Ti (cycle interval time) can vary, for example, based on a predefined value or a user-defined input, without limitation. Additionally, the pseudocode presented is provided as an example and may be implemented in various other ways. It can also be adapted to accommodate different data structures or operational requirements as needed.

Following the completion of block 520, the decision block 530 evaluates whether the character determined by block 520 differs from the character currently displayed at the text cursor or input insertion position. If the characters differ, the character at the text cursor or input insertion position is replaced, or caused to be replaced, with the character determined by block 520. This may be accomplished by sending suitable data, which, in certain implementations, can involve sending one or more simulated backspace keystrokes. These backspace keystrokes effectively move the display cursor one or more positions backward, delete the character(s) at that position, and shift any subsequent text backward by one or more characters. This is then followed by sending one or more simulated keystrokes to generate the replacement character. For example, in one non-limiting embodiment, the replacement character may be generated by sending synthesized keystroke(s) using the Windows SendInput API. In another non-limiting embodiment, the replacement character may be generated using synthesized keystroke(s) sent via the macOS CGEvent API. Additionally, in a further non-limiting implementation, the replacement character may be generated by sending a synthesized sequence of scan codes that can be recognized and interpreted by the recipient host.

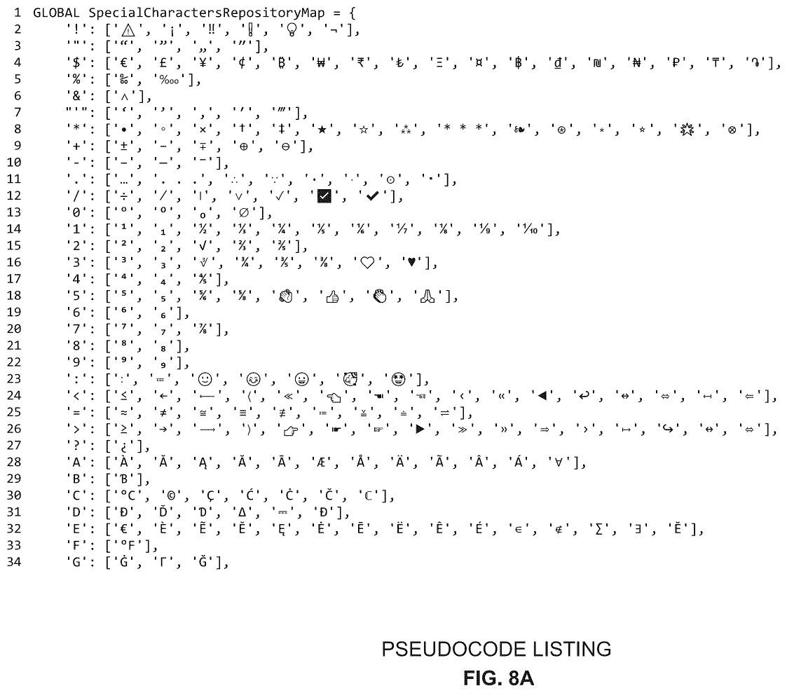

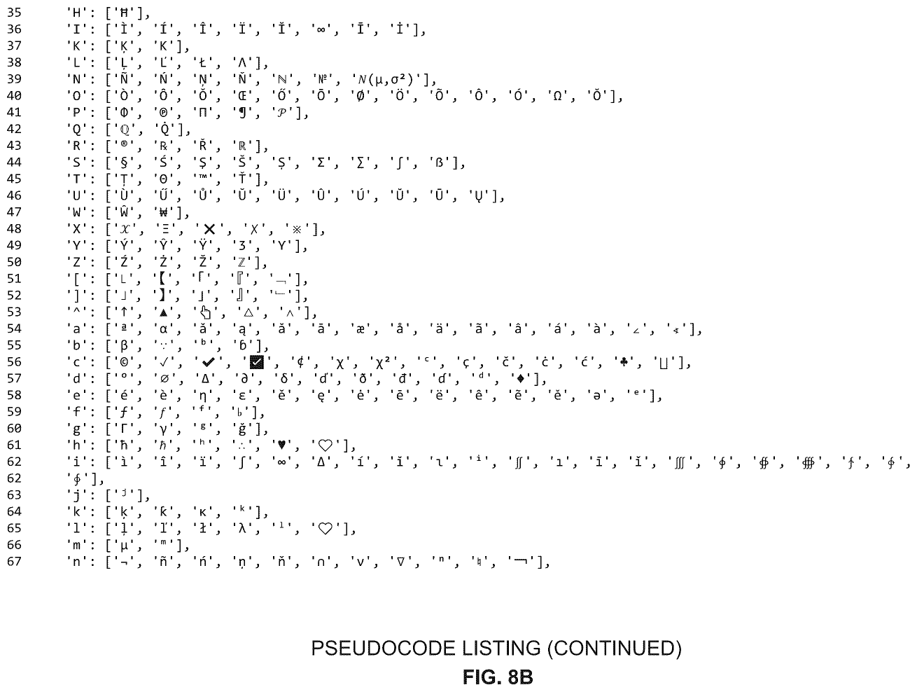

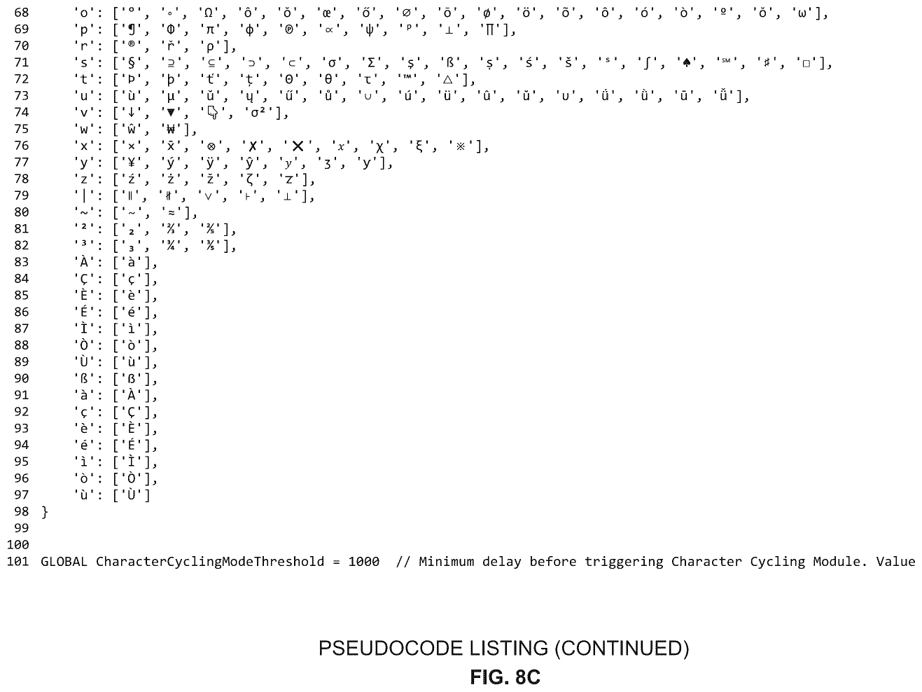

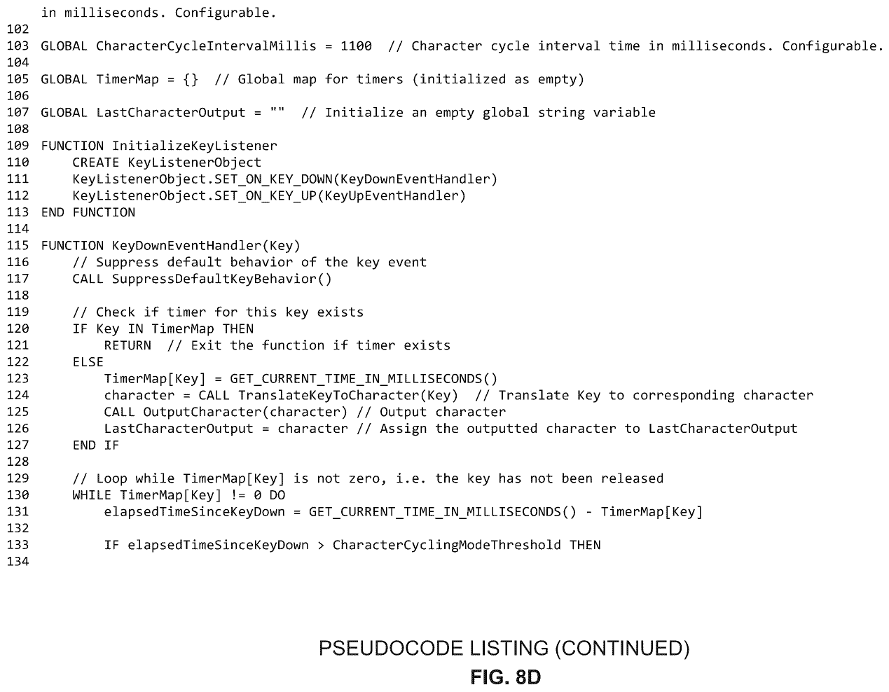

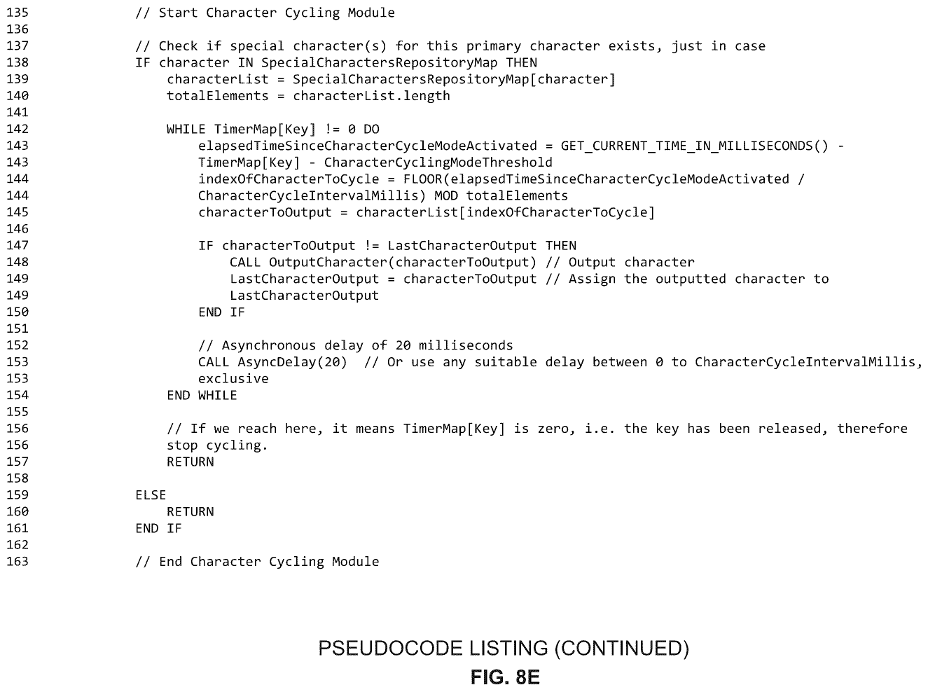

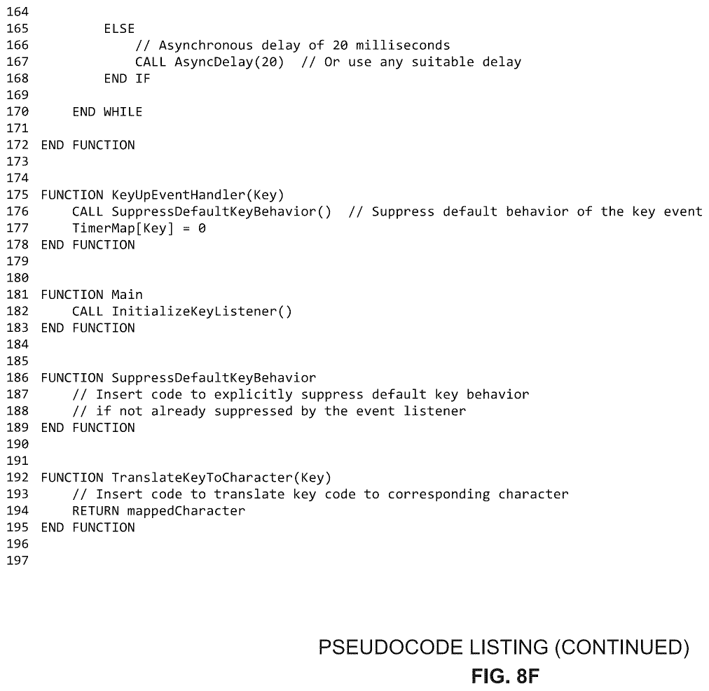

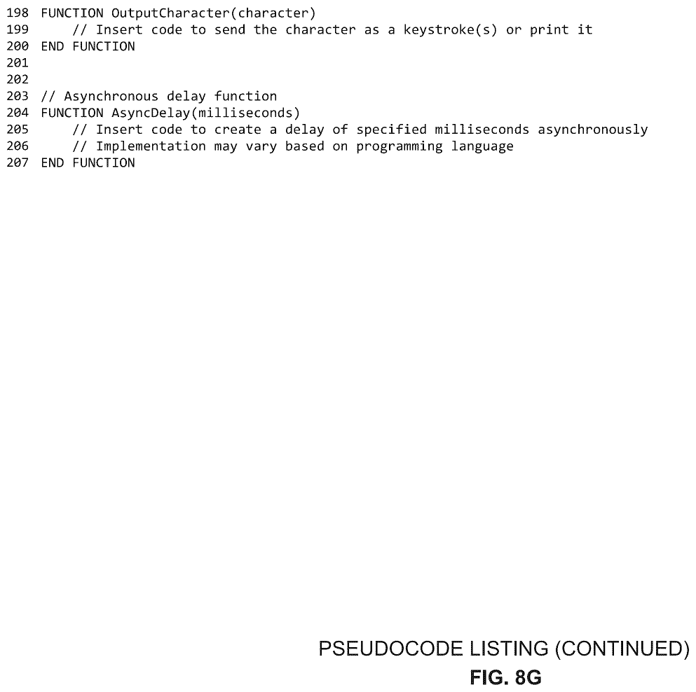

FIGS. 8A through 8G illustrate pseudocode for one implementation of the special characters repository 402, key receiver and interceptor module 404, and character cycling module 406. These figures provide an overview of the operational logic utilized within each module.

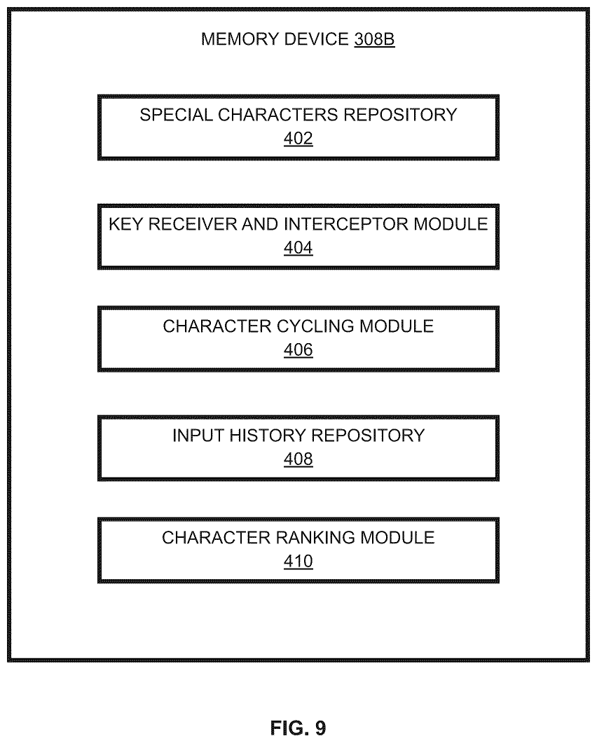

Referring now to FIG. 9, this figure is a block diagram of another embodiment of a memory device 308B. The memory device 308B includes a special characters repository 402, a key receiver and interceptor module 404, and a character cycling module 406 included in memory device 308A discussed with reference to FIG. 4. At least in the embodiment illustrated in FIG. 9, the memory device 308B further includes, among other components and/or features, an input history repository 408 and a character ranking module 410.

An input history repository 408 may include any suitable hardware and/or software that can store and alter data. As such, the input history repository 408 may include any suitable type of data repository and/or data repository that is known or developed in the future.

In various embodiments, the input history repository 408 is configured to store user-typed inputs. This repository retains all characters produced by keystrokes, with the necessity of such input capture further elaborated upon in connection with the character ranking module 410. The key receiver and interceptor, as previously described, is reconfigured to capture and record every keystroke that produces or alters a character, including whitespace characters, as generated by the user. For example, when the E key is pressed, the character “e” is stored in the input history repository. Conversely, if the user presses Shift+E, the resulting character “E” is stored. Additionally, if the Backspace or Delete key is subsequently activated, the previously stored character—whether “e” or “E”—is removed from the input history repository.

The character data stored in the input history repository may also include pertinent metadata, such as timestamps. The repository is preferably organized in a structure that facilitates fast retrieval, enabling quick access to data based on various criteria, such as time periods or specific character matches. For instance, a hash table may allow for rapid lookups of entries by character, while a time-based index could enable efficient retrieval of entries within a specific timeframe.

Additionally, the input history repository may encompass a plurality of databases or data structures, which may not necessarily be mutually exclusive, allowing for a tailored implementation to suit the needs of various embodiments. This functionality ensures comprehensive monitoring of user input, facilitating precise tracking and retrieval of all character-generating activities.

To safeguard user data, the input history repository is preferably encrypted at rest using industry-standard methodologies. Acceptable encryption techniques may include the Advanced Encryption Standard (AES), RSA encryption, or other recognized encryption algorithms, whether known or developed in the future. Additionally, to further enhance data protection, the repository may be limited in size such that, once a predefined maximum number of entries is reached, older entries are automatically pruned to accommodate new ones. These measures collectively ensure that user information remains secure and accessible solely to designated components of the system, thereby bolstering the overall integrity and confidentiality of the data.

A character ranking module 410 may include any suitable hardware and/or software that can assess and prioritize characters based on any suitable criteria or criterion, including contextual factors. This may encompass contextual data (such as data from input history repository 408) or other relevant information necessary for its assessment and prioritization process. This functionality facilitates the prioritization of pertinent characters for a user, affording the user swift access to the most relevant character while minimizing the need for the user to sift through less relevant characters. Consequently, this module enhances user efficiency and significantly improves the overall user experience.

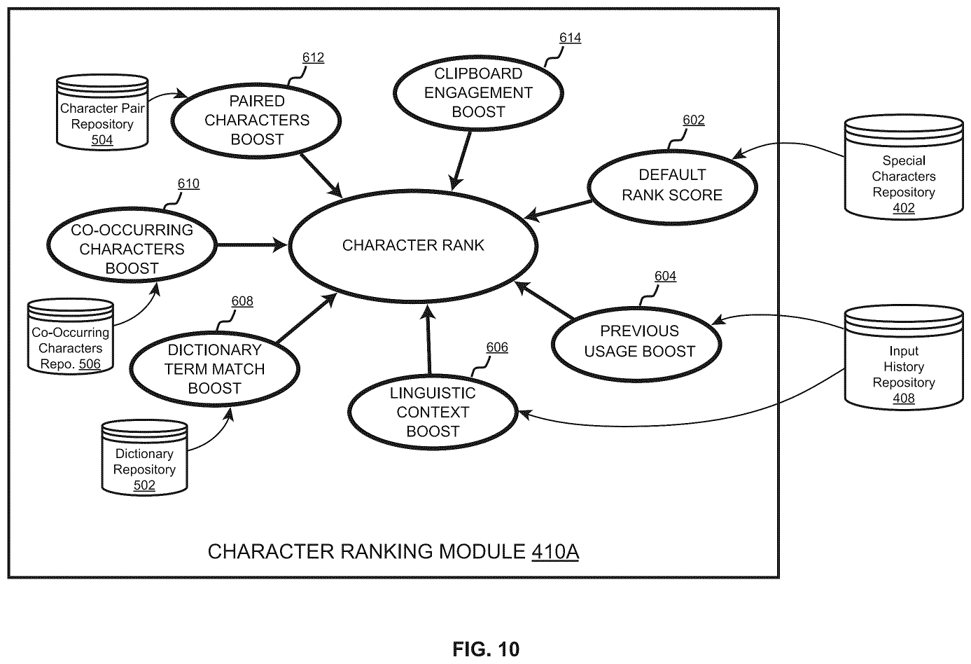

FIG. 10 provides a conceptual overview of one implementation of a character ranking module 410A, illustrating various criteria influencing the ranking process and their relationships between other modules and components.

A default rank score 602 is retrieved from the special characters repository 402, which is pre-populated with a baseline score for each character in the repository. For illustration purposes, the baseline scores assigned to various characters may include, for example, a score of 6.0 for the euro sign (€), 5.0 for the pound sign (£), 4.5 for the yen/yuan sign (¥), 4.0 for the cent sign ( [symbol] ), 2.2 for the bitcoin symbol ( [symbol] ), and 2.0 for the won symbol ( [symbol] ). These scores reflect the relative popularity and relevance of each character based on general research findings.

In absence of other influencing scores, characters with higher baseline scores are prioritized and displayed first during character cycling. For instance, assuming the dollar sign ($) is associated with the aforementioned characters, when the $ key is pressed and held for at least the character cycling threshold duration, the euro sign (€) is displayed at the text cursor or input insertion point, replacing the dollar sign ($). If the key remains pressed beyond the cycle interval time, the pound sign (£) is displayed, replacing the euro sign (€). Similarly, if the key continues to be beyond subsequent cycle intervals, the yen/yuan sign (¥) is displayed, replacing the pound sign (£), and so on.

A previous usage boost 604 enhances the ranking of characters that a user has previously entered. The rationale for this up-weighting adjustment is that frequent usage of specific characters can indicate higher relevance to the user's current entry needs. Building upon the currency symbol examples discussed earlier, if the user has previously selected or entered the bitcoin symbol ( [symbol] ) on ten occasions, the module may apply a boost of ten points to the bitcoin symbol's ranking score. This boost prioritizes the bitcoin symbol ( [symbol] ) over other special characters with less prior engagement from the user, in the absence of other influencing factors.

In practice, this might mean that if the bitcoin symbol ( [symbol] ) has a baseline score of 2.2 and the previous usage boost adds an additional 10 points, its adjusted score becomes 12.2, elevating its position in the sequence of character results. The previous visit boost is particularly beneficial for enabling users to quickly access frequent used characters without sifting through less relevant options. By recognizing the value of prior interactions, this feature streamlines the user experience and delivers characters that are more likely to align with the user's current entry needs based on their input history.

A linguistic context boost 606 enhances the ranking of characters by considering the linguistic context of the user's recent input. This context may include various aspects of language, such as grammar, semantics, and syntax. Additionally, discourse context—referring to the surrounding text that provides relevant background information—may also be considered. Various linguistic indicators, such as the user's keyboard layouts and device language settings, can further contribute to this evaluation.

By evaluating the language of the user's recent text input, characters matching the detected language can be prioritized. For example, if the user's recent text input is identified as French, special characters commonly used in French—such as ‘é’, ‘à’, ‘è’, ‘«’, ‘»’, ‘ê’, ‘°’, ‘ô’, ‘ [symbol] ’, ‘ù’, ‘â’, ‘î’, ‘ë’, ‘É’, ‘œ’, ‘À’, ‘ï’, ‘û’, ‘ü’, ‘È’, ‘Ê’, ‘Ô’, [symbol] , ‘Ù’, ‘Â’, ‘Î’, ‘Ë’, ‘Æ’, ‘Ï’, ‘Û’, ‘Ü’, ‘æ’, ‘ÿ’, ‘ [symbol] ’, ‘Ÿ’, and ‘·’—may receive a ranking boost compared to characters in other languages. Similarly, if the user's recent text input is identified as Spanish, special characters commonly used in Spanish—such as ‘ó’, ‘í’, ‘á’, ‘é’, ‘ñ’, ‘ú’, ‘ [symbol] ’, ‘Ó’, ‘ [symbol] ’, ‘Á’, ‘É’, ‘Ú’, ‘ü’, ‘Í’, ‘Ñ’, and ‘Ü’—may be prioritized.

This feature enables a more intuitive input experience by tailoring special character rankings based on linguistic context. The linguistic context boost therefore plays a critical role in customizing character results to meet the linguistic needs of users effectively. Techniques for evaluating the language of a given text may include heuristic methods, such as analyzing the presence of specific characters or diacritics unique to certain languages, as well as statistical analysis and natural language processing.

In addition to evaluating the language of the user's recent text input, the linguistic context boost may also consider the language settings of the user's device. For instance, in a Windows operating environment, the installed and/or active keyboard layout(s) may be obtained through the GetKeyboardLayout API, serving as a strong indicator of the user's proficiency in one or more languages. Furthermore, the home country setting of the device may also be taken into account. For example, in a Windows environment, the home country can be determined by retrieving the “HKEY_CURRENT_USER\Control Panel\International\Geo” registry information.

Country data can provide valuable insights into the potential language preferences and proficiencies of a user. For example, research suggests that approximately 90% to 93% of the Netherlands population can converse in English, 71% in German, 29% in French, and 5% in Spanish. Based on this data, if the country data for a user indicates the Netherlands, special characters associated with German, French, and Spanish may receive higher rankings.

An example of analyzing the grammatical structure and semantic relationships within the user's input involves determining the prioritization of an en dash (-) or an em dash (—). En dashes (-) are typically used to indicate ranges, such as in numbers or dates (e.g., ‘2020-2021,’ ‘January 1-December 31’) or to connect related items (e.g., ‘the New York-London flight’). In contrast, em dashes (—) are often employed to create emphasis or to set off additional information within a sentence. By analyzing the grammatical structure and semantic context of the user's input, the system can determine whether an en dash or an em dash should be prioritized.

For instance, if the input includes numbers or phrases indicating a range or connection (e.g., ‘the years 2019-2021’), an en dash would be prioritized. Conversely, if the input suggests an interruption or a strong break in thought (e.g., ‘The results—while promising—were inconclusive’), an em dash could be favored. This nuanced approach to grammatical and semantic analysis enhances the prioritization of contextually appropriate characters, improving the user's input experience.

A dictionary term match boost 608 considers the user's currently typed content, such as focusing on the last word at the cursor position. This mechanism identifies matches within a dictionary repository populated with terms from one or more suitable languages. For example, if a user types the word ‘souffl’ and then activates character cycling mode, the system retrieves entries from the dictionary repository where terms begin with ‘souffl’ followed by any special character. This may yield results such as ‘soufflâmes,’ ‘soufflât,’ ‘soufflâtes,’ ‘soufflèrent,’ ‘soufflète,’ ‘soufflètent,’ ‘soufflètera,’ ‘soufflèterai,’ ‘soufflèteraient,’ ‘soufflèterais,’ ‘soufflèterait,’ ‘soufflèteras,’ ‘soufflèterez,’ ‘soufflèteriez,’ ‘soufflèterions,’ ‘soufflèterons,’ ‘soufflèteront,’ ‘soufflètes,’ ‘soufflé,’ ‘soufflée,’ ‘soufflées,’ and ‘soufflés’.

By extracting the seventh character from each result and filtering for uniqueness, characters such as ‘â,’ ‘è,’ and ‘é’ can be derived and assigned higher rankings due to their linguistic connection. It will be appreciated by those skilled in the art that the dictionary repository and/or the retrieval and extraction process may be modified in various ways to produce similar results in identifying relevant linguistic connections and characters.

Additionally, previously typed words, phrases, or content of any suitable length may be considered to provide further context for interpreting the user's intent. For instance, if the words typed prior to ‘souffl’ are ‘How to make chocolate,’ the system may determine that ‘soufflé’ is the most likely intended term, resulting in an even higher ranking for the character ‘é.’ Overall, the dictionary term match boost ensures that users are presented with characters closely aligned with their typed content, enhancing the relevance and quality of character results.

A co-occurring characters boost 610 enhances the ranking of characters based on their frequent association with the user's recently inputted text or content. This feature recognizes that certain characters commonly appear together within specific contexts, such as in academic papers, articles, or specialized publications.

For example, a set of associated characters, which may be referred to as the ‘engineering symbol set,’ could include Δ, Ω, α, β, γ, σ, τ, φ, χ, ρ, ε, μ, λ, ν, ζ, κ, θ, ∫, Σ, ∇, ∝, η, ≈, ≠, ≡, ≤, ≥, ∝, ⊕, ⊗, ⊥, ∠, ∧, ∨, ∈, ∉, ∃, [symbol] , |, ±, °, ‰, [symbol] , [symbol] , [symbol] , [symbol] , ↔, →, ←, ↓, [symbol] , ┌, ┐, └, ┘, [symbol] , [symbol] , ξ, ψ, π, ∪, ∩, [symbol] , Ø, -, ∴, ∵, [symbol] , [symbol] , ⊂, ⊃, and T. If a user has recently typed one or more characters from this set (e.g., ‘17’ and ‘Σ’), it becomes likely that other characters within the same set will be relevant to the current input and thus receive an enhanced ranking score.

Similarly, another set of associated characters, which may be referred to as the ‘legal symbol set,’ could include § (section sign), ¶ (paragraph mark), © (copyright symbol),® (registered trademark symbol), [symbol] (sound recording copyright symbol),™ (trademark symbol), ℠ (service mark symbol), ∧ (logical and symbol), ∨ (logical or symbol), † (dagger symbol for secondary footnotes), and ‡ (double dagger symbol for tertiary footnotes). If the user has recently entered one or more characters from the legal symbol set, other characters within the same set may receive an elevated ranking score.

Additionally, text analysis techniques can be employed to extract insights from the user's recent input history, such as identifying the subject matter of the text. Characters relevant to the identified subject matter may then be prioritized. Furthermore, any number of character sets can be defined to cover a wide range of contexts, including broad industries or subject fields (e.g., ‘electrical engineering character set,’ ‘optical engineering character set,’′chemical engineering character set,′ or ‘statistics character set’) as well as specific use cases. Each character set may contain any suitable number of characters. By accommodating character sets of varying breadth and depth, the system ensures adaptability to diverse typographic needs and scenarios.

A paired characters boost 612 enhances the ranking of specific character combinations that are frequently associated with one another. Unlike general co-occurring characters, commonly paired characters exhibit a higher likelihood of appearing together, warranting a greater influence on their ranking scores.

For example, the characters ‘«’ and ‘>’ are often used as quotation marks, particularly in Danish, French, Greek, Italian, Portuguese, and Spanish texts. Similarly, the characters ‘┌’ and ‘┘’ frequently appear in conjunction in Japanese texts. In another non-limiting example, the prime symbol (′) and double prime symbol (″) are commonly paired in measurements. When a user has previously inputted one character from a pair, the system recognizes its association with the other character and elevates the ranking of the associated character accordingly.

Any number of paired sets can be defined to accommodate various subject matters and use cases. Each paired set may contain two or more characters. By recognizing inherent relationships among paired characters, the paired characters boost enhances the relevance of character results, providing a more user-centric and intuitive typing experience.

A clipboard engagement boost 614 enhances the ranking of characters that a user has copied to their device's clipboard. This mechanism recognizes that when users actively copy a special character—such as from a web page or document—it may indicate a heightened level of interest or intent to reenter that character in the future. By leveraging this behavior, the system prioritizes characters in the ranking process based on their historical and/or current presence in the clipboard, thereby increasing the likelihood of displaying characters that are particularly relevant to the user.

For example, if a user conducts an internet search for the won symbol ( [symbol] ) and copies it to the clipboard, this action signals to the ranking module a potential interest in the won symbol. Consequently, the clipboard engagement boost prioritizes the won symbol in the ranking process, ensuring its prominence in subsequent character selection interactions.

This approach streamlines the user's character selection experience by increasing the likelihood of presenting characters aligned with their needs, thereby fostering a more efficient and satisfying typing experience.

In conclusion, the overall character score is derived by aggregating the scores from the various ranking criteria discussed above, each reflecting factors that contribute to the relevance of a character. This composite score serves as a critical input and can be utilized by any suitable method, system, or interface—such as a display interface, a special characters palette, or a character cycling module—to prioritize the presentation of relevant characters, thereby enhancing the user experience.

It should be noted that the criteria outlined herein are non-exhaustive and non-limiting; one or more of these criteria may be used in conjunction with additional criteria that may be implemented. Furthermore, the weights assigned to each ranking criterion can vary based on implementation preferences, enabling tailored calculations to suit specific contexts. Implementers may adjust these weights as necessary or even omit certain criteria entirely, reflecting the adaptable nature of the ranking process. This adaptability ensures that the ranking process can evolve over time, accommodating the dynamic nature of language and the changing needs of users. Such flexibility allows for continuous improvement and refinement, ultimately enhancing the relevance and effectiveness of character prioritization.

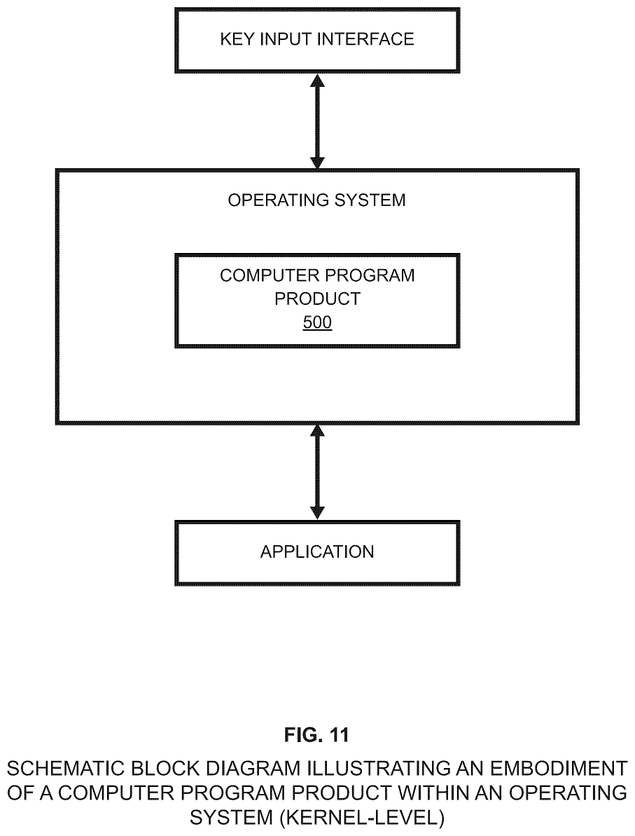

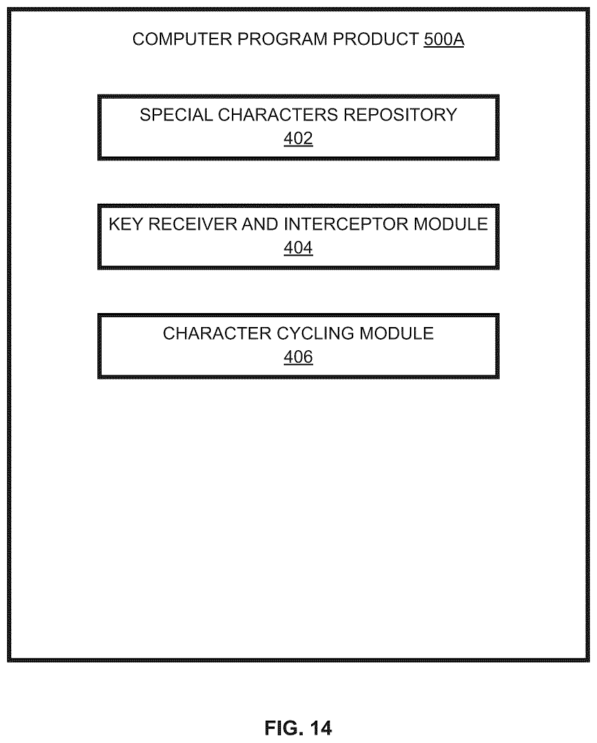

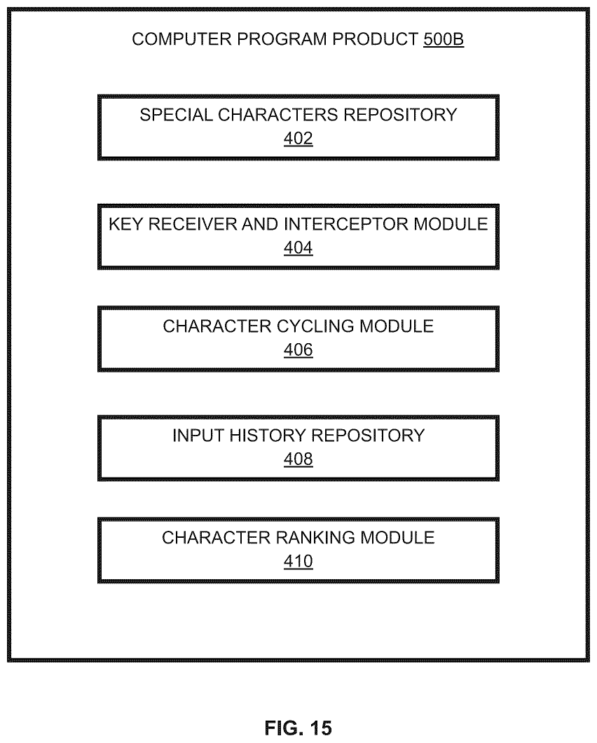

Referring now to the FIGS. 11-13, Computer Program Product 500 represents three general embodiments of the invention, as described herein. The specific implementations of these embodiments are further illustrated and described as Computer Program Product 500A (in FIG. 14) and Computer Program Product 500B (in FIG. 15), each comprising varying components. These implementations are exemplary and not limiting, illustrating how the components of the disclosure may be adapted for different scenarios.

FIG. 11 illustrates an embodiment of a Computer Program Product integrated as part of an operating system kernel. In this configuration, the Computer Program Product operates within the operating system to enable the described functionality. Input is received from a key input interface, processed by the operating system, and passed to applications as required. The Computer Program Product is depicted as a subcomponent within the operating system, emphasizing its role as part of the kernel.

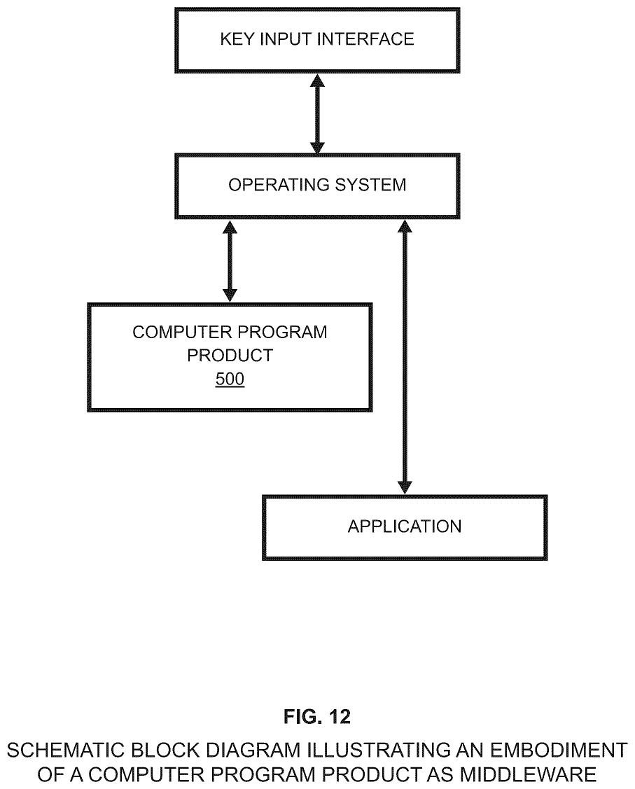

FIG. 12 illustrates an embodiment of a Computer Program Product implemented as middleware between an operating system and an application. In this configuration, the Computer Program Product intercepts key down and key up events from the operating system before they reach an application. After processing these key events, the middleware program may generate output data, which is sent back to the operating system and subsequently propagated to all relevant applications, thereby enabling the functionality described in this disclosure.

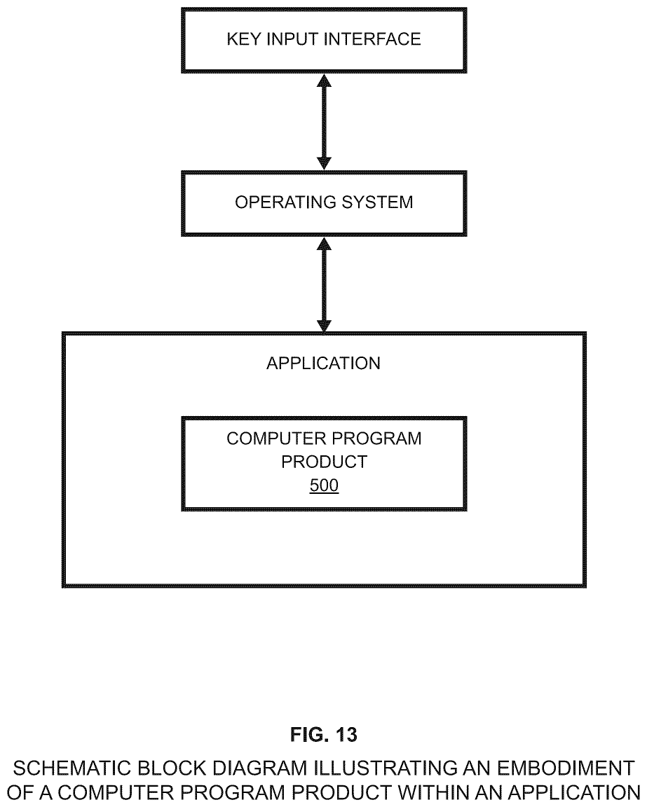

FIG. 13 illustrates an embodiment of a Computer Program Product integrated directly into an application. In this configuration, the Computer Program Product functions as a part of the application, enabling the described functionality. Input is received from the key input interface, processed by the operating system, and handled within the application itself, where the Computer Program Product operates as part of the application.

The configurations shown in FIGS. 11-13 are exemplary and provided for illustrative purposes only. The Computer Program Product may be implemented at any software layer, including but not limited to the operating system, middleware, or application level, without deviating from the scope of the invention.

FIG. 14 illustrates a schematic block diagram of a first implementation of a Computer Program Product, comprising components including a special characters repository 402, a key receiver and interceptor module 404, and a character cycling module 406, all included in the memory device 308A discussed with reference to FIG. 4.

FIG. 15 illustrates a schematic block diagram of a second implementation of a Computer Program Product, comprising components including a special characters repository 402, a key receiver and interceptor module 404, a character cycling module 406, an input history repository 408, and a character ranking module 410, all included in the memory device 308B discussed with reference to FIG. 9.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

With regard to the processes, systems, methods, user interface, heuristics, etc. described herein, it should be understood that, although the steps of such processes, etc. have been described as occurring according to a certain ordered sequence, such processes could be practiced with the described steps performed in an order other than the order described herein. It further should be understood that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems, methods, and user interface will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising a display screen and a key input interface, the computing device being configured to initiate automatic cycling that sequentially displays on the display screen each content element from a set of content elements when a character key on the key input interface is pressed and held for at least a threshold duration until the release of the character key, wherein only one content element from the set of content elements is displayed at any moment, and wherein the automatic cycling loops back to the first content element in the set of content elements after the last content element in the set of content elements.

2. The computing device of claim 1, wherein the set of content elements comprises special characters associated with the character key.

3. The computing device of claim 1, wherein the threshold duration is between 0.2 and 4 seconds.

4. The computing device of claim 1, wherein each content element in the set of content elements is displayed at a text cursor position or input insertion point on the display screen as the content element is sequentially displayed.

5. The computing device of claim 1, wherein the automatic cycling sequentially displays each content element from the set of content elements at time intervals between 0.2 and 4 seconds.

6. The computing device of claim 1, further configured to stop the automatic cycling if the automatic cycling is active when a first designated key on the key input interface is pressed, and to manually cycle to the next content element in the set of content elements, looping back to the first content element in the set of content elements after the last content element in the set of content elements.

7. The computing device of claim 6, wherein the first designated key is a space key.

8. The computing device of claim 1, further configured to stop the automatic cycling if the automatic cycling is active when a second designated key on the key input interface is pressed, and to manually cycle to the previous content element in the set of content elements, looping back to the last content element in the set of content elements after the first content element in the set of content elements.

9. The computing device of claim 8, wherein the second designated key is a backspace key.

10. The computing device of claim 1, wherein the set of content elements is ordered by relevance to a user.

11. The computing device of claim 1, wherein multiple character keys on the key input interface are each associated with a respective set of content elements, and pressing and holding one of the multiple character keys initiates the automatic cycling.

12. The computing device of claim 1, wherein the computing device is a mobile telephone and/or a handheld computing device.

13. The computing device of claim 1, wherein the computing device is a personal computer.

14. A computer program product comprising a non-transitory computer-readable storage medium having computer-readable code embodied in the medium which, when running on a computing device, causes the computing device to initiate automatic cycling that sequentially displays each content element from a set of content elements on the computing device's display screen when a character key on a key input interface is pressed and held for at least a threshold duration, continuing until the release of the character key, wherein only one content element from the set of content elements is displayed at any moment, and wherein the automatic cycling loops back to the first content element in the set of content elements after the last content element in the set of content elements.

15. The computer program product of claim 14, wherein the computer-readable code comprises an operating system program.

16. The computer program product of claim 14, wherein the set of content elements comprises special characters associated with the character key.

17. The computer program product of claim 14, wherein the threshold duration is between 0.2 and 4 seconds.

18. The computer program product of claim 14, wherein the computer-readable code is operable to cause each content element in the set of content elements to be displayed at a text cursor position or input insertion point on the display screen.

19. The computer program product of claim 14, wherein the computer-readable code is operable to cause the automatic cycling to sequentially display each content element from the set of content elements at time intervals from 0.2 to 4 seconds.

20. The computer program product of claim 14, wherein the computer-readable code is operable to stop the automatic cycling if the automatic cycling is active when a first designated key on the key input interface is pressed, and to manually cycle to the next content element in the set of content elements, looping back to the first content element in the set of content elements after the last content element in the set of content elements.

21. The computer program product of claim 20, wherein the first designated key is configured to be a space key.

22. The computer program product of claim 14, wherein the computer-readable code is operable to stop the automatic cycling if the automatic cycling is active when a second designated key on the key input interface is pressed, and to manually cycle to the previous character in the set of content elements, looping back to the last content element in the set of content elements after the first content element in the set of content elements.

23. The computer program product of claim 22, wherein the second designated key is configured to be a backspace key.

24. The computer program product of claim 14, wherein the computer-readable code is operable to order or reorder the set of content elements based on relevance to a user.

25. The computer program product of claim 14, wherein multiple character keys on the key input interface are each associated with a respective set of content elements, and pressing and holding one of the multiple character keys initiates the automatic cycling.

26. A system comprising:
a display screen;
a key input interface; and
a computing node comprising a non-transitory computer readable storage medium having program instructions embodied therewith, the program instructions executable by a processor of the computing node to cause the processor to perform a method comprising:
when a character key on the key input interface is pressed and held for at least a threshold duration until the release of the character key, initiating automatic cycling that comprises:
displaying a first content element of a set of content elements on the display screen;
sequentially displaying, on the display screen, at least one other content element from a set of content elements;
displaying, after all of the set of content elements have been displayed, the first content element on the display screen;
wherein only one content element from the set of content elements is displayed simultaneously.

27. A computer program product, the computer program product comprising a non-transitory computer readable storage medium having program instructions embodied therewith, the program instructions executable by a processor to cause the processor to perform a method comprising:
when a character key on a key input interface is pressed and held for at least a threshold duration until the release of the character key, initiating automatic cycling that comprises:
displaying a first content element of a set of content elements on a display screen;
sequentially displaying, on the display screen, at least one other content element from a set of content elements;
displaying, after all of the set of content elements have been displayed, the first content element on the display screen;
wherein only one content element from the set of content elements is displayed simultaneously.
